(19) United States
(12) Patent Application Publication
(10) Pub. No.: US 2016/0217888 A1
(43) Pub. Date: Jul. 28, 2016

(54) POWER CABLE GAS BARRIER

(71) Applicant: SCHLUMBERGER TECHNOLOGY CORPORATION, Sugar Land, TX (US)

(72) Inventors: Jinglei Xiang, Lawrence, KS (US); Jason Holzmueller, Lawrence, KS (US); Gregory H. Manke, Overland Park, KS (US)

(21) Appl. No.: 14/914,255

(22) PCT Filed: Sep. 4, 2014
(86) PCT No.: PCT/US2014/053970

§ 371 Date: Feb. 24, 2016

Related U.S. Application Data
(60) Provisional application No. 61/873,527, filed on Sep. 4, 2013.

(51) Int. Cl. H01B 9/00; E21B 17/00; H01B 3/42; H01B 3/44; H01B 13/06; H01B 13/14

(52) U.S. Cl. CPC H01B 9/00; H01B 13/06; H01B 13/14; H01B 3/427; H01B 3/445; E21B 17/003

(57) ABSTRACT

A power cable can include a conductor and a layer disposed radially about the conductor where the layer includes graphene nanosheets in a polymeric matrix.

### RELATED APPLICATIONS

This application claims priority to and the benefit of a U.S. provisional application having Ser. No. 61/873,527, filed 4 Sep. 2013, which is incorporated by reference herein.

### BACKGROUND

Equipment used in the oil and gas industry may be exposed to high-temperature and/or high-pressure environments. Such environments may also be chemically harsh, for example, consider environments that may include chemicals such as hydrogen sulfide, carbon dioxide, etc. Various types of environmental conditions can damage equipment.

### SUMMARY

A power cable can include a conductor and a layer disposed radially about the conductor where the layer includes graphene nanosheets in a polymeric matrix. A method can include providing graphene nanosheets in a polymeric matrix as a tape; and wrapping the tape about a conductor. A method can include providing graphene nanosheets in a polymeric matrix; and extruding the graphene nanosheets in the polymeric matrix about a conductor. Various other apparatuses, systems, methods, etc., are also disclosed.

This summary is provided to introduce a selection of concepts that are further described below in the detailed description. However, many modifications are possible without materially departing from the teachings of this disclosure. Accordingly, such modifications are intended to be included within the scope of this disclosure as defined in the claims.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in geologic environments;

FIG. 2 illustrates an example of an electric submersible pump system;

FIG. 3 illustrates examples of equipment;

FIG. 4 illustrates an example of a power cable;

FIG. 5 illustrates an example of a motor lead extension;

FIG. 6 illustrates examples of methods and examples of cables;

FIG. 7 illustrates examples of structures and an example of a method;

FIG. 8 illustrates an example of a micrograph of an example of a material;

FIG. 9 illustrates an example of a micrograph of an example of a material;

FIG. 10 illustrates an example of a process and examples of material;

FIG. 11 illustrates examples of material layers;

FIG. 12 illustrates an example of a plot of gas transmission data;

FIG. 13 illustrates an example of a plot of gas transmission data;

FIG. 14 illustrates an example of a cable;

FIG. 15 illustrates an example of a method;

FIG. 16 illustrates an example of a system; and

FIG. 17 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

A gas well may be defined by its gas oil ratio (GOR). For example, some states have statutes that provide definitions, for example, where a gas well is one where the GOR is greater than 100,000 ft³/bbl or 100 Mcf/bbl.

In high GOR wells, an electric submersible pump (ESP) power cables and motor lead extensions (MLEs) may be exposed to high concentration of corrosive and sour gases and fluids. To protect dielectric layers and copper conductors, metallic lead (Pb) sheaths can be employed as a barrier layer to block permeation of downhole media. However, due to toxicity of free lead (Pb), lead (Pb) use is becoming more regulated. In certain applications the weight and increased cable size required for lead (Pb) sheathed cables can impact ease of handling and installation. As an example, a cable may include one or more carbon-based layers that hinder gas transport (e.g., act as a gas barrier). In such an example, the one or more carbon-based layers may provide gas barrier properties, fluid resistant properties and heat resistant properties and may reduce cable weight, for example, when compared to cable weight for a cable that includes one or more lead-based (Pb-based) layers.

As an example, as a substitute for a lead (Pb) sheath, a composite structure that includes one or more polymers and graphene nanosheet (e.g., or “nanoplatelets”) may be used. Such a composite structure may exhibit gas barrier properties and chemical and heat resistance. Such a composite structure may include aligned substructures therein. As an example, tortuosity of a graphene/polymer composite structure may be established via orientation of graphene nanosheets, for example, that may act to reduce gas diffusion while, for example, reducing cable weight (e.g., compared to those that use lead (Pb)) and, for example, cross-sectional area.

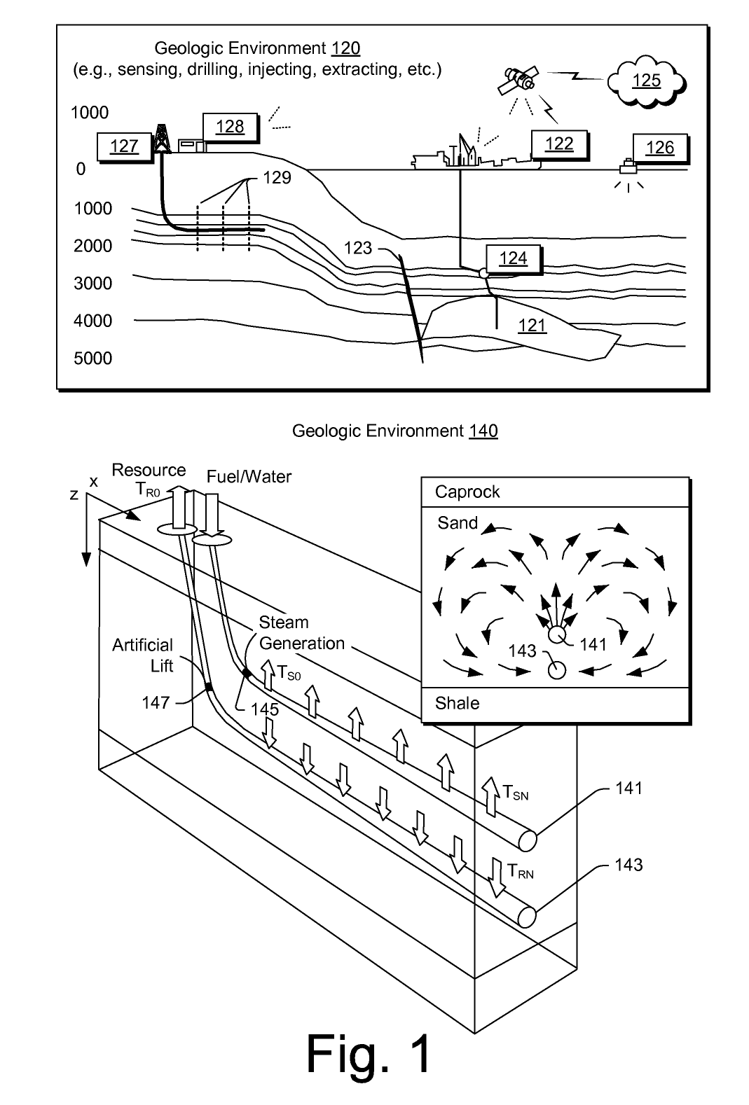

FIG. 1 shows examples of geologic environments 120 and 140. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, etc.

As to the geologic environment 140, as shown in FIG. 1, it includes two wells 141 and 143 (e.g., bores), which may be, for example, disposed at least partially in a layer such as a sand layer disposed between caprock and shale. As an example, the geologic environment 140 may be outfitted with equipment 145, which may be, for example, steam assisted gravity drainage (SAGD) equipment for injecting steam for enhancing extraction of a resource from a reservoir. SAGD is a technique that involves subterranean delivery of steam to enhance flow of heavy oil, bitumen, etc. SAGD can be applied for Enhanced Oil Recovery (EOR), which is also known as tertiary recovery because it changes properties of oil in situ.

As an example, a SAGD operation in the geologic environment 140 may use the well 141 for steam-injection and the well 143 for resource production. In such an example, the equipment 145 may be a downhole steam generator and the equipment 147 may be an electric submersible pump (e.g., an ESP). As an example, one or more electrical cables may be connected to the equipment 145 and one or more electrical cables may be connected to the equipment 147. For example, as to the equipment 145, a cable may provide power to a heater to generate steam, to a pump to pump water (e.g., for steam generation), to a pump to pump fuel (e.g., to burn to generate steam), etc. As to the equipment 147, for example, a cable may provide power to power a motor, power a sensor (e.g., a gauge), etc.

As illustrated in a cross-sectional view of FIG. 1, steam injected via the well 141 may rise in a subterranean portion of the geologic environment and transfer heat to a desirable resource such as heavy oil. In turn, as the resource is heated, its viscosity decreases, allowing it to flow more readily to the well 143 (e.g., a resource production well). In such an example, equipment 147 may then assist with lifting the resource in the well 143 to, for example, a surface facility (e.g., via a wellhead, etc.).

As to a downhole steam generator, as an example, it may be fed by three separate streams of natural gas, air and water (e.g., via conduits) where a gas-air mixture is combined first to create a flame and then the water is injected downstream to create steam. In such an example, the water can also serve to cool a burner wall or walls (e.g., by flowing in a passageway or passageways within a wall). As an example, a SAGD operation may result in condensed steam accompanying a resource (e.g., heavy oil) to a well. In such an example, where a production well includes artificial lift equipment such as an ESP, operation of such equipment may be impacted by the presence of condensed steam (e.g., water). Further, as an example, condensed steam may place demands on separation processing where it is desirable to separate one or more components from a hydrocarbon and water mixture.

Each of the geologic environments 120 and 140 of FIG. 1 may include harsh environments therein. For example, a harsh environment may be classified as being a high-pressure and high-temperature environment. A so-called HPHT environment may include pressures up to about 138 MPa (e.g., about 20,000 psi) and temperatures up to about 205 degrees C. (e.g., about 400 degrees F.), a so-called ultra-HPHT environment may include pressures up to about 241 MPa (e.g., about 35,000 psi) and temperatures up to about 260 degrees C. (e.g., about 500 degrees F.) and a so-called HPHT-hc environment may include pressures greater than about 241 MPa (e.g., about 35,000 psi) and temperatures greater than about 260 degrees C. (e.g., about 500 degrees F.). As an example, an environment may be classified based in one of the aforementioned classes based on pressure or temperature alone. As an example, an environment may have its pressure and/or temperature elevated, for example, through use of equipment, techniques, etc. For example, a SAGD operation may elevate temperature of an environment (e.g., by 100 degrees C. or more).

As an example, an environment may be classified based at least in part on its chemical composition. For example, where an environment includes hydrogen sulfide (H₂S), carbon dioxide (CO₂), etc., the environment may be corrosive to certain materials. As an example, an environment may be classified based at least in part on particulate matter that may be in a fluid (e.g., suspended, entrained, etc.). As an example, particulate matter in an environment may be abrasive or otherwise damaging to equipment. As an example, matter may be soluble or insoluble in an environment and, for example, soluble in one environment and substantially insoluble in another.

Conditions in a geologic environment may be transient and/or persistent. Where equipment is placed within a geologic environment, longevity of the equipment can depend on characteristics of the environment and, for example, duration of use of the equipment as well as function of the equipment. For example, a high-voltage power cable may itself pose challenges regardless of the environment into which it is placed. Where equipment is to endure in an environment over a substantial period of time, uncertainty may arise in one or more factors that could impact integrity or expected lifetime of the equipment. As an example, where a period of time may be of the order of decades, equipment that is intended to last for such a period of time should be constructed with materials that can endure environmental conditions imposed thereon, whether imposed by an environment or environments and/or one or more functions of the equipment itself.

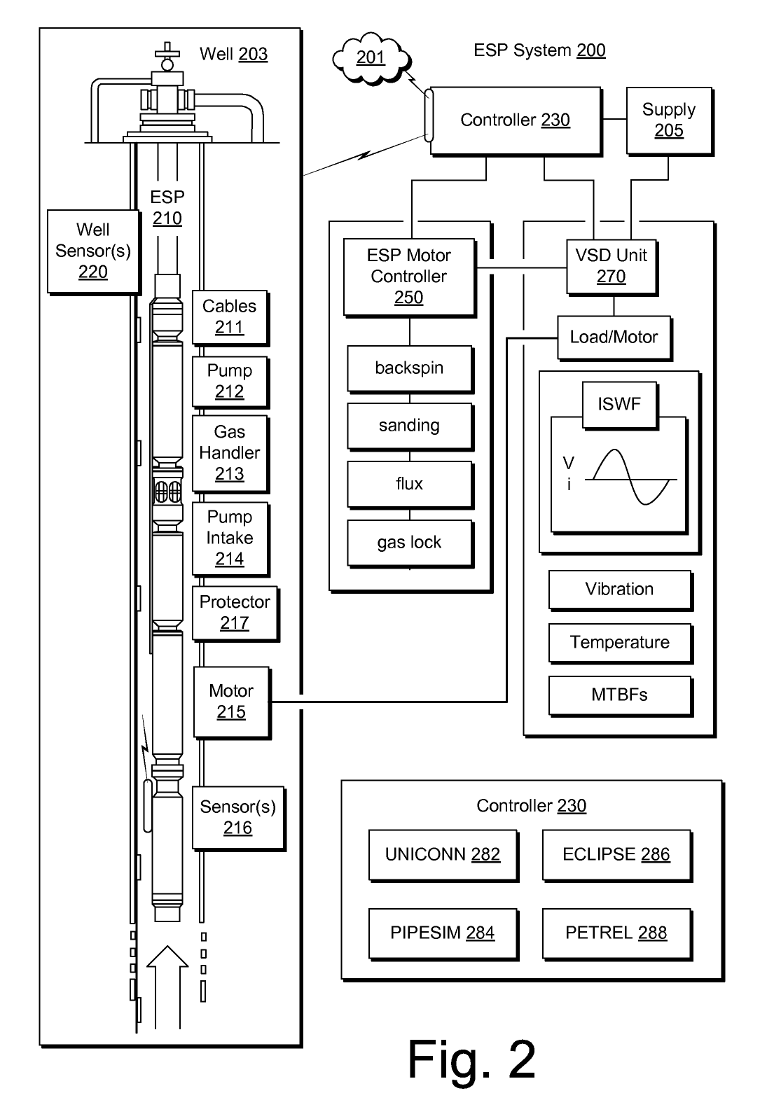

FIG. 2 shows an example of an ESP system 200 that includes an ESP 210 as an example of equipment that may be placed in a geologic environment. As an example, an ESP may be expected to function in an environment over an extended period of time (e.g., optionally of the order of years). As an example, a commercially available ESP (such as one of the REDA™ ESPs marketed by Schlumberger Limited, Houston, Tex.) may be employed to pump fluid(s).

In the example of FIG. 2, the ESP system 200 includes a network 201, a well 203 disposed in a geologic environment, a power supply 205, the ESP 210, a controller 230, a motor controller 250 and a variable speed drive (VSD) unit 270. The power supply 205 may receive power from a power grid, an onsite generator (e.g., natural gas driven turbine), or other source. The power supply 205 may supply a voltage, for example, of about 4.16 kV or more.

As shown, the well 203 includes a wellhead that can include a choke (e.g., a choke valve). For example, the well 203 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

As to the ESP 210, it is shown as including cables 211 (e.g., or a cable), a pump 212, gas handling features 213, a pump intake 214, a motor 215, one or more sensors 216 (e.g., temperature, pressure, current leakage, vibration, etc.) and optionally a protector 217. The well 203 may include one or more well sensors 220. As an example, a fiber-optic based sensor or other type of sensor may provide for real time sensing of temperature, for example, in SAGD or other operations. As shown in the example of FIG. 1, a well can include a relatively horizontal portion. Such a portion may collect heated heavy oil responsive to steam injection. Measurements of temperature along the length of the well can provide for feedback, for example, to understand conditions downhole of an ESP. Well sensors may extend into a well and beyond a position of an ESP.

In the example of FIG. 2, the controller 230 can include one or more interfaces, for example, for receipt, transmission or receipt and transmission of information with the motor controller 250, the VSD unit 270, the power supply 205 (e.g., a gas fueled turbine generator, a power company, etc.), the network 201, equipment in the well 203, equipment in another well, etc.

As shown in FIG. 2, the controller 230 can include or provide access to one or more modules or frameworks. Further, the controller 230 may include features of a motor controller and optionally supplant the motor controller 250. For example, the controller 230 may include the UNICONN™ motor controller 282 marketed by Schlumberger Limited (Houston, Tex.). In the example of FIG. 2, the controller 230 may access one or more of the PIPESIM™ framework 284, the ECLIPSE™ framework 286 marketed by Schlumberger Limited (Houston, Tex.) and the PETREL™ framework 288 marketed by Schlumberger Limited (Houston, Tex.) (e.g., and optionally the OCEAN™ framework marketed by Schlumberger Limited (Houston, Tex.)).

In the example of FIG. 2, the motor controller 250 may be a commercially available motor controller such as the UNICONN™ motor controller. As an example, the UNICONN™ motor controller can perform some control and data acquisition tasks for ESPs, surface pumps or other monitored wells. For example, the UNICONN™ motor controller can interface with the PHOENIX™ monitoring system, for example, to access pressure, temperature and vibration data and various protection parameters as well as to provide direct current power to downhole sensors. The UNICONN™ motor controller can interface with fixed speed drive (FSD) controllers or a VSD unit, for example, such as the VSD unit 270.

For FSD controllers, the UNICONN™ motor controller can monitor ESP system three-phase currents, three-phase surface voltage, supply voltage and frequency, ESP spinning frequency and leg ground, power factor and motor load.

For VSD units, the UNICONN™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

The UNICONN™ motor controller can include control functionality for VSD units such as target speed, minimum and maximum speed and base speed (voltage divided by frequency); three jump frequencies and bandwidths; volts per hertz pattern and start-up boost; ability to start an ESP while the motor is spinning; acceleration and deceleration rates, including start to minimum speed and minimum to target speed to maintain constant pressure/load (e.g., from about 0.01 Hz/10,000 s to about 1 Hz/s); stop mode with PWM carrier frequency; base speed voltage selection; rocking start frequency, cycle and pattern control; stall protection with automatic speed reduction; changing motor rotation direction without stopping; speed force; speed follower mode; frequency control to maintain constant speed, pressure or load; current unbalance; voltage unbalance; overvoltage and undervoltage; ESP backspin; and leg-ground.

In the example of FIG. 2, the motor controller 250 includes various modules to handle, for example, backspin of an ESP, sanding of an ESP, flux of an ESP and gas lock of an ESP. As an example, the motor controller 250 may include one or more of such features, other features, etc.

In the example of FIG. 2, the VSD unit 270 may be a low voltage drive (LVD) unit, a medium voltage drive (MVD) unit or other type of unit (e.g., a high voltage drive, which may provide a voltage in excess of about 4.16 kV). For a LVD, a VSD unit can include a step-up transformer, control circuitry and a step-up transformer while, for a MVD, a VSD unit can include an integrated transformer and control circuitry. As an example, the VSD unit 270 may receive power with a voltage of about 4.16 kV and control a motor as a load with a voltage from about 0 V to about 4.16 kV.

The VSD unit 270 may include commercially available control circuitry such as the SPEEDSTAR™ MVD control circuitry marketed by Schlumberger Limited (Houston, Tex.). The SPEEDSTAR™ MVD control circuitry is suitable for indoor or outdoor use and comes standard with a visible fused disconnect switch, precharge circuitry, and sine wave output filter (e.g., integral sine wave filter, ISWF) tailored for control and protection of high-horsepower ESPs. The SPEEDSTAR™ MVD control circuitry can include a plug-and-play sine wave output filter, a multilevel PWM inverter output, a 0.95 power factor, programmable load reduction (e.g., soft-stall function), speed control circuitry to maintain constant load or pressure, rocking start (e.g., for stuck pumps resulting from scale, sand, etc.), a utility power receptacle, an acquisition system for the PHOENIX™ monitoring system, a site communication box to support surveillance and control service, a speed control potentiometer. The SPEEDSTAR™ MVD control circuitry can optionally interface with the UNICONN™ motor controller, which may provide some of the foregoing functionality.

In the example of FIG. 2, the VSD unit 270 is shown along with a plot of a sine wave (e.g., achieved via a sine wave filter that includes a capacitor and a reactor), responsiveness to vibration, responsiveness to temperature and as being managed to reduce mean time between failures (MTBFs). The VSD unit 270 may be rated with an ESP to provide for about 40,000 hours (5 years) of operation (e.g., depending on environment, load, etc.). The VSD unit 270 may include surge and lightening protection (e.g., one protection circuit per phase). As to leg-ground monitoring or water intrusion monitoring, such types of monitoring may indicate whether corrosion is or has occurred. Further monitoring of power quality from a supply, to a motor, at a motor, may occur by one or more circuits or features of a controller.

While the example of FIG. 2 shows an ESP that may include centrifugal pump stages, another type of ESP may be controlled. For example, an ESP may include a hydraulic diaphragm electric submersible pump (HDESP), which is a positive-displacement, double-acting diaphragm pump with a downhole motor. HDESPs find use in low-liquid-rate coalbed methane and other oil and gas shallow wells that require artificial lift to remove water from the wellbore. HDESPs may handle a wide variety of fluids and, for example, up to about 2% sand, coal, fines and H₂S/CO₂.

As an example, an ESP may include a REDA™ HOTLINE™ high-temperature ESP motor. Such a motor may be suitable for implementation in various types of environments. As an example, a REDA™ HOTLINE™ high-temperature ESP motor may be implemented in a thermal recovery heavy oil production system, such as, for example, SAGD system or other steam-flooding system.

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation. As an example, a motor may be a multiphase motor. As an example, a motor may include windings, etc., for three or more phases.

For connection to a power cable or motor lead extensions (MLEs), a motor may include a pothead. Such a pothead may, for example, provide for a tape-in connection with metal-to-metal seals (e.g., to provide a barrier against fluid entry). A motor may include one or more types of potheads or connection mechanisms. As an example, a pothead unit may be provided as a separate unit configured for connection, directly or indirectly, to a motor housing.

As an example, a motor may include dielectric oil (e.g., or dielectric oils), for example, that may help lubricate one or more bearings that support a shaft rotatable by the motor. A motor may be configured to include an oil reservoir, for example, in a base portion of a motor housing, which may allow oil to expand and contract with wide thermal cycles. As an example, a motor may include an oil filter to filter debris.

As an example, a motor housing can house stacked laminations with electrical windings extending through slots in the stacked laminations. The electrical windings may be formed from magnet wire that includes an electrical conductor and at least one polymeric dielectric insulator surrounding the electrical conductor. As an example, a polymeric insulation layer may include a single layer or multiple layers of dielectric tape that may be helically wrapped around an electrical conductor and that may be bonded to the electrical conductor (e.g., and to itself) through use of an adhesive. As an example, a motor housing may include slot liners. For example, consider a material that can be positioned between windings and laminations. As an example, a motor may include one or more materials (e.g., slot liners, layers about a conductor, etc.) that include carbon-based nanoplatelets and one or more polymers.

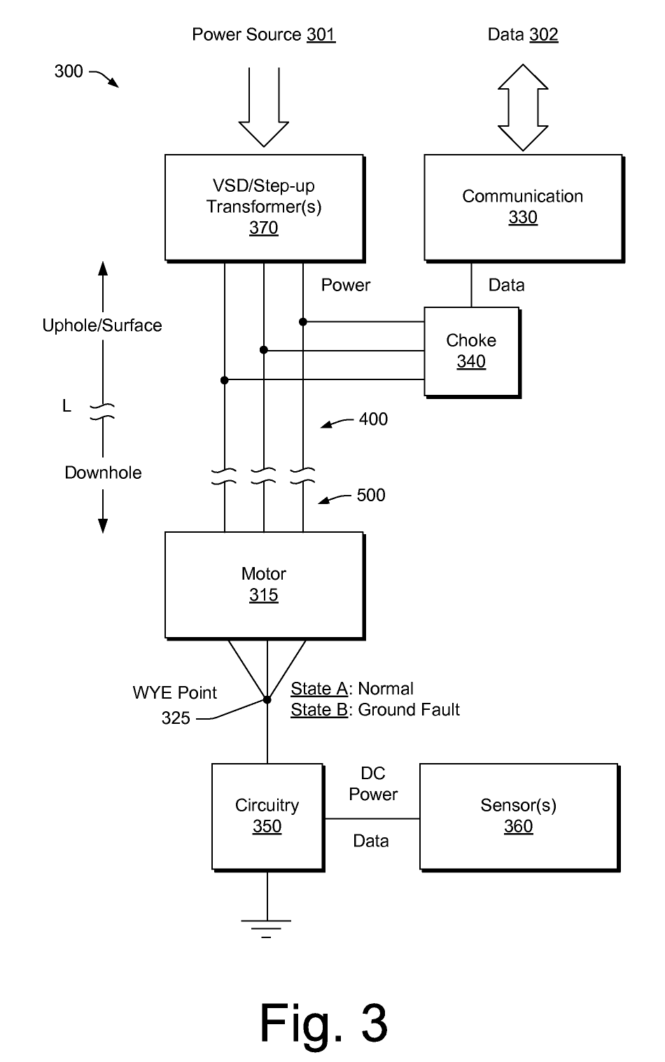

FIG. 3 shows a block diagram of an example of a system 300 that includes a power cable 400 and MLEs 500. As shown, the system 300 includes a power source 301 as well as data 302. In the example of FIG. 3, the power source 301 can provide power to a VSD/step-up transformer block 370 while the data 302 may be provided to a communication block 330. The data 302 may include instructions, for example, to instruct circuitry of the circuitry block 350, one or more sensors of the sensor block 360, etc. The data 302 may be or include data communicated, for example, from the circuitry block 350, the sensor block 360, etc. In the example of FIG. 3, a choke block 340 can provide for transmission of data signals via the power cable 400 and the MLEs 500.

As shown, the MLEs 500 connect to a motor block 315, which may be a motor (or motors) of a pump (e.g., an ESP, etc.) and be controllable via the VSD/step-up transformer block 370. In the example of FIG. 3, the conductors of the MLEs 500 electrically connect at a WYE point 325. The circuitry block 350 may derive power via the WYE point 325 and may optionally transmit, receive or transmit and receive data via the WYE point 325. As shown, the circuitry block 350 may be grounded.

The system 300 can operate in a normal state (State A) and in a ground fault state (State B). One or more ground faults may occur for any of a variety of reasons. For example, wear of the power cable 400 may cause a ground fault for one or more of its conductors. As another example, wear of one of the MLEs may cause a ground fault for its conductor. As an example, gas intrusion, fluid intrusion, etc. may degrade material(s), which may possibly lead a ground fault.

The system 300 may include provisions to continue operation of a motor of the motor block 315 when a ground fault occurs. However, when a ground fault does occur, power at the WYE point 325 may be altered. For example, where DC power is provided at the WYE point 325 (e.g., injected via the choke block 340), when a ground fault occurs, current at the WYE point 325 may be unbalanced and alternating. The circuitry block 350 may or may not be capable of deriving power from an unbalanced WYE point and, further, may or may not be capable of data transmission via an unbalanced WYE point.

The foregoing examples, referring to “normal” and “ground fault” states, demonstrate how ground faults can give rise to various issues. Power cables and MLEs that can resist damaging forces, whether mechanical, electrical or chemical, can help ensure proper operation of a motor, circuitry, sensors, etc. Noting that a faulty power cable (or MLE) can potentially damage a motor, circuitry, sensors, etc. Further, as mentioned, an ESP may be located several kilometers into a wellbore. Accordingly, the time and cost to replace a faulty ESP, power cable, MLE, etc., can be substantial.

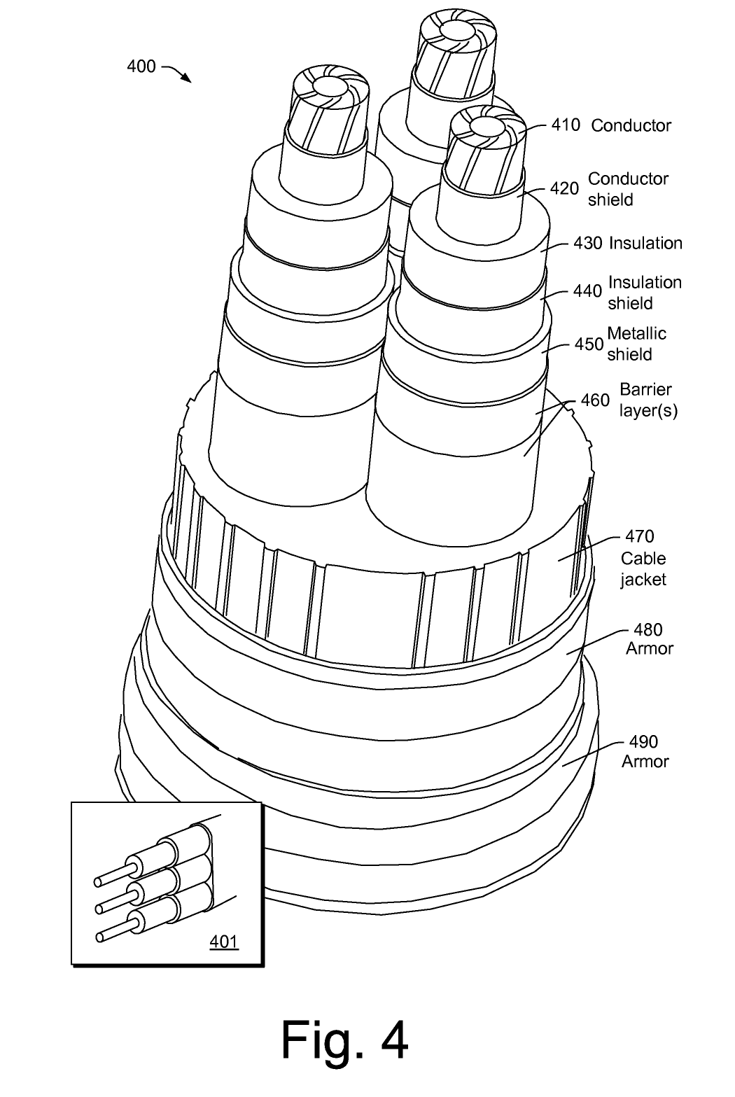

FIG. 4 shows an example of the power cable 400, suitable for use in the system 300 of FIG. 3 or optionally one or more other systems (e.g., SAGD, etc.). In the example of FIG. 4, the power cable 400 includes three conductor assemblies where each assembly includes a conductor 410, a conductor shield 420, insulation 430, an insulation shield 440, a metallic shield 450, and one or more barrier layers 460. The three conductor assemblies are seated in a cable jacket 470, which is surrounded by a first layer of armor 480 and a second layer of armor 490. As to the cable jacket 470, it may be round or as shown in an alternative example 401, rectangular (e.g., “flat”).

As an example, a power cable may include, for example, conductors that are made of copper (see, e.g., the conductors 410); an optional conductor shield for each conductor (see, e.g., the conductor shield 420), which may be provided for voltage ratings in excess of about 5 kV; insulation such as high density polyethylene (HDPE), polypropylene or EPDM (e.g., where the E refers to ethylene, P to propylene, D to diene and M refers to a classification in ASTM standard D-1418; e.g., ethylene copolymerized with propylene and a diene) dependent on temperature rating (see, e.g., the insulation 430); an optional insulation shield (see, e.g., the insulation shield 440), which may be provided for voltage ratings in excess of about 5 kV; an optional metallic shield that may include lead (Pb) (see, e.g., the metallic shield 450); a barrier layer that may include fluoropolymer tape (see, e.g., the barrier layer(s) 460); a jacket that may include oil resistant EPDM or nitrile rubber (see, e.g., the cable jacket 470); and one or more layers of armor that may include galvanized, stainless steel, MONEL™ alloy (marketed by Inco Alloys International, Inc., Huntington, W. Va.), etc. (see, e.g., the armor 480 and the armor 490).

As an example, the metallic shield 450 and the one or more barrier layers 460 may be considered barrier layers or a barrier layer, for example, which may be formed of a continuous lead (Pb) sheath or fluoropolymer extrusion or tape wrap (e.g., depending on different conditions of a well or wells).

In some commercially available REDAMAX™ cables, polytetrafluoroethylene (PTFE) tape is used to form a barrier layer to block fluid and gas entry. For REDALEAD™ cables, lead (Pb) is extruded directly on top of the insulation (see, e.g., the insulation shield 440) to prevent diffusion of gases into the insulation. The high barrier properties and malleability of lead (Pb) makes it a good candidate for downhole cable components.

As mentioned, however, free lead (Pb) has associated toxicity. Lead (Pb) may also give rise to manufacturing issues. For example, impurities of lead (Pb) may lead to formation of intermetallic compounds that may make extrusion processes quite difficult. As an example, some failures may occur in the fields that may possibly be associated with stress cracking, crevice corrosion and/or cold creep of lead (Pb) barriers (e.g., as failure modes). As an example, the high density of lead (Pb) may add substantial weight to finished cable/MLE products, which can increase transportation cost, impact handling (e.g., installation on a rig), etc. Use of lead (Pb) may impact slack management (e.g., e.g., consider applications that involve coiled tubing).

As an example, a cable may include a material that exhibits gas barrier properties and chemical inertness and heat resistance where such a material may include graphene. As an example, such a material may be a substitute for lead (Pb), for example, as a barrier material.

In the example of FIG. 4, as to the conductor 410, it may be solid or compacted stranded high purity copper and coated with a metal (e.g., tin, lead, nickel, silver or other metal or alloy). As to the conductor shield 420, it may optionally be a semiconductive material with a resistivity less than about 5000 ohm-m and be adhered to the conductor 410 in a manner that acts to reduce voids therebetween (e.g., consider a substantially voidless adhesion interface). As an example, the conductor shield 420 may be provided as an extruded polymer that penetrates into spaces between strands of the stranded conductor 410. As to extrusion of the conductor shield 420, it may optionally be co-extruded or tandem extruded with the insulation 430 (e.g., which may be EPDM). As an option, nanoscale fillers may be included for low resistivity and suitable mechanical properties (e.g., for high temperature thermoplastics).

As to the Insulation 430, it may be bonded to the conductor shield 420. As an example, the insulation 430 may include polyether ether ketone (PEEK) or EPDM. Where suitable, PEEK may be selected to provide for improved thermal cycling.

As to the insulation shield 440, it may optionally be a semiconductive material having a resistivity less than about 5000 ohm-m. The insulation shield 440 may be adhered to the insulation 430, but, for example, removable for splicing, without leaving any substantial amounts of residue. As an example, the insulation shield 440 may be extruded polymer, for example, co-extruded with the insulation 430.

As to the metallic shield 450 and the barrier layer(s) 460, one or more layers of material may be provided. As an example, a composite material may be provided that does not include lead (Pb) where such a composite material acts as a barrier, for example, tending to be resistant to downhole fluids and gases. One or more layers may be provided, for example, to create an impermeable gas barrier. As an example, the cable 400 may include PTFE fluoropolymer, for example, as tape that may be helically taped (e.g., optionally in addition to a composite material).

As to the cable jacket 470, it may be round or as shown in the example 401, rectangular (e.g., “flat”). As to material of construction, a cable jacket may include one or more layers of EPDM, nitrile, hydrogenated nitrile butadiene rubber (HNBR), fluoropolymer, chloroprene, or other material (e.g., to provide for resistance to a downhole and/or other environment). As an example, each conductor assembly phase may include solid metallic tubing, such that splitting out the phases is more easily accomplished (e.g., to terminate at a connector, to provide improved cooling, etc.).

As to the cable armor 480 and 490, metal or metal alloy may be employed, optionally in multiple layers for improved damage resistance.

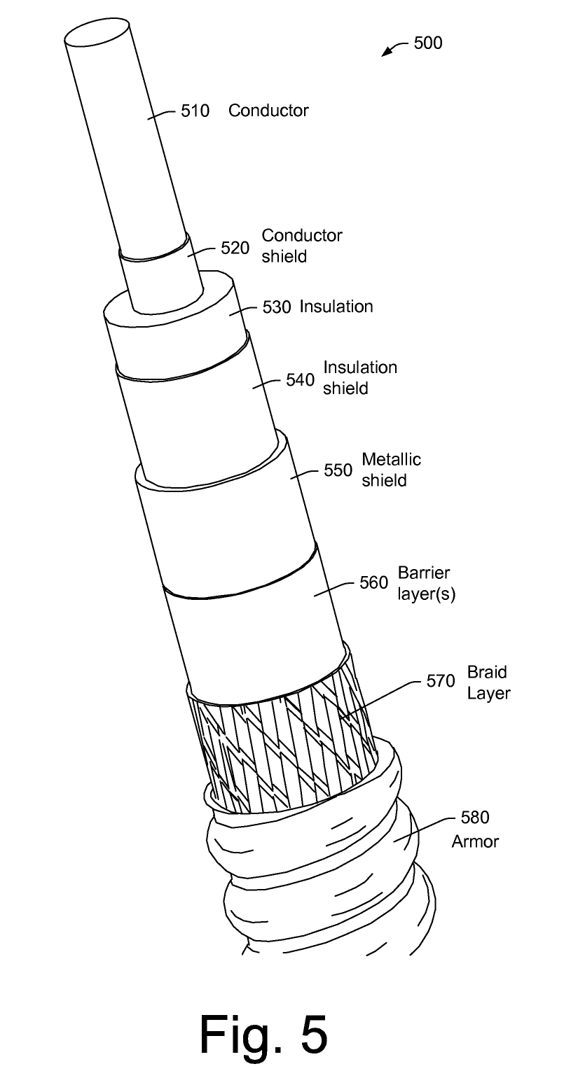

FIG. 5 shows an example of one of the MLEs 500 suitable for use in the system 300 of FIG. 3 or optionally one or more other systems (e.g., SAGD, etc.). In the example of FIG. 5, the MLE 500 (or “lead extension”) a conductor 510, a conductor shield 520, insulation 530, an insulation shield 540, an optional metallic shield 550, one or more barrier layers 560, a braid layer 570 and armor 580. While the example of FIG. 5 mentions MLE or “lead extension”, it may be implemented as a single conductor assembly cable for any of a variety of downhole uses.

As an example, a MLE may include a composite material that does not include lead (Pb). For example, such a material may be suited for use in forming one or more barrier layers (e.g., optionally without use of a metallic shield such as a lead-based metallic shield). As an example, a cable may not include lead (Pb) while one or more MLEs may include (Pb) (e.g., or not include lead (Pb)). As MLEs tend to be short in length compared to a power cable, an amount of lead (Pb) and its associated pros and cons may be considered acceptable for inclusion in one or more MLEs.

As to a braid of a braided layer, various types of materials may be used such as, for example, polyethylene terephthalate (PET) (e.g., applied as a protective braid, tape, fabric wrap, etc.). PET may be considered as a low cost and high strength material. As an example, a braid layer can help provide protection to a soft lead jacket during an armor wrapping process. In such an example, once downhole, the function of the braid may be minimal. As to other examples, nylon or glass fiber tapes and braids may be implemented. Yet other examples can include fabrics, rubberized tapes, adhesive tapes, and thin extruded films.

As an example, a conductor (e.g., solid or stranded) may be surrounded by a semiconductive material layer that acts as a conductor shield where, for example, the layer has a thickness greater than approximately 0.005 inch (e.g., approximately 0.127 mm). As an example, a cable can include a conductor with a conductor shield that has a radial thickness of approximately 0.010 inch (e.g., approximately 0.254 mm). As an example, a cable can include a conductor with a conductor shield that has a radial thickness in a range from greater than approximately 0.005 inch to approximately 0.015 inch (e.g., approximately 0.127 mm to approximately 0.38 mm).

As an example, a conductor may have a conductor size in a range from approximately #8 AWG (e.g., OD approx. 0.128 inch or area of approx. 8.36 mm²) to approximately #2/0 “00” AWG (e.g., OD approx. 0.365 inch or area of approx. 33.6 mm²). As examples, a conductor configuration may be solid or stranded (e.g., including compact stranded). As an example, a conductor may be smaller than #8 AWG or larger than #2/0 “00” AWG (e.g., #3/0 “000” AWG, OD approx. 0.41 inch or area of approx. 85 mm²).

As an example, one or more layers of a cable may be made of a material that is semiconductive (e.g., a semiconductor). Such a layer (e.g., or layers) may include a polymer or polymer blend with one or more conductive fillers (e.g., carbon black, graphene, carbon nanotubes, etc.) and optionally one or more additives (e.g., elastomer compound components, process aids, etc.). For example, a layer may include a polyolefin polymer (e.g., EPDM, etc.) and a graphite filler (e.g., expanded graphite, etc.). As an example, a layer may include a polyaryletherketone (PAEK) polymer and a graphite filler (e.g., expanded graphite, etc.). For example, a layer may include PEEK as a thermoplastic and a graphite filler (e.g., expanded graphite, etc.). As an example, a layer may include a fluoropolymer and a graphite filler (e.g., expanded graphite, etc.).

As an example, a cable may include a conductor that has a size within a range of approximately 0.1285 inch to approximately 0.414 inch (e.g., approximately 3.26 mm to approximately 10.5 mm) and a conductor shield layer that has a radial thickness within a range of approximately greater than 0.005 inch to approximately 0.015 inch (e.g., approximately 0.127 mm to approximately 0.38 mm).

As an example, a cable may include a conductor with a conductor shield (e.g., optionally a semiconductor layer) and insulation (e.g., an insulation layer) where the conductor shield and the insulation are extruded. For example, the conductor shield may be extruded onto the conductor followed by extrusion of the insulation onto the conductor shield. Such a process may be performed, for example, using a co-extrusion, a sequential extrusion, etc.

As an example, an insulation shield (e.g., an insulator shield layer) may be extruded onto insulation after the insulation has been extruded onto a conductor shield (e.g., with an appropriate delay to allow for hardening of the insulation). In such a manner, the insulation shield may be more readily removed from the insulation, for example, when making cable connections (e.g., where stripping of the insulation shield is desired).

As an example, a cable may include a conductor shield, insulation and an insulation shield that have been extruded separately (e.g., by separate extruders with a delay to allow for hardening, etc.). As an example, a cable may include a conductor shield, insulation and insulation shield formed via co-extrusion, for example, using separate extrusion bores that feed to an appropriate cross-head, extrusion die or dies that deposit the layers in a substantially simultaneous manner (e.g., within about a minute or less).

In comparison to tape, extrusion may provide for a reduction in the overall dimension of a cable (e.g., in some oil field applications, well clearance may be a concern). Extruded layers tend to be smoother than tape, which can help balance out an electrical field. For example, a tape layer or layers over a conductor can have laps and rough surfaces that can cause voltage stress points. Taping for adjacent layers via multiple steps may risk possible contamination between the layers. In contrast, a co-extrusion process may be configured to reduce such contamination. For example, co-extrusion may help to reduce voids (e.g., consider a substantially voidless, continuous or “solid” configuration), contamination, or rough spots at a conductor shield/insulation interface, which could create stress points where discharge and cable degradation could occur. Thus, for improved reliability, smoothness and cleanness, a conductor shield may be extruded, optionally co-extruded with insulation thereon.

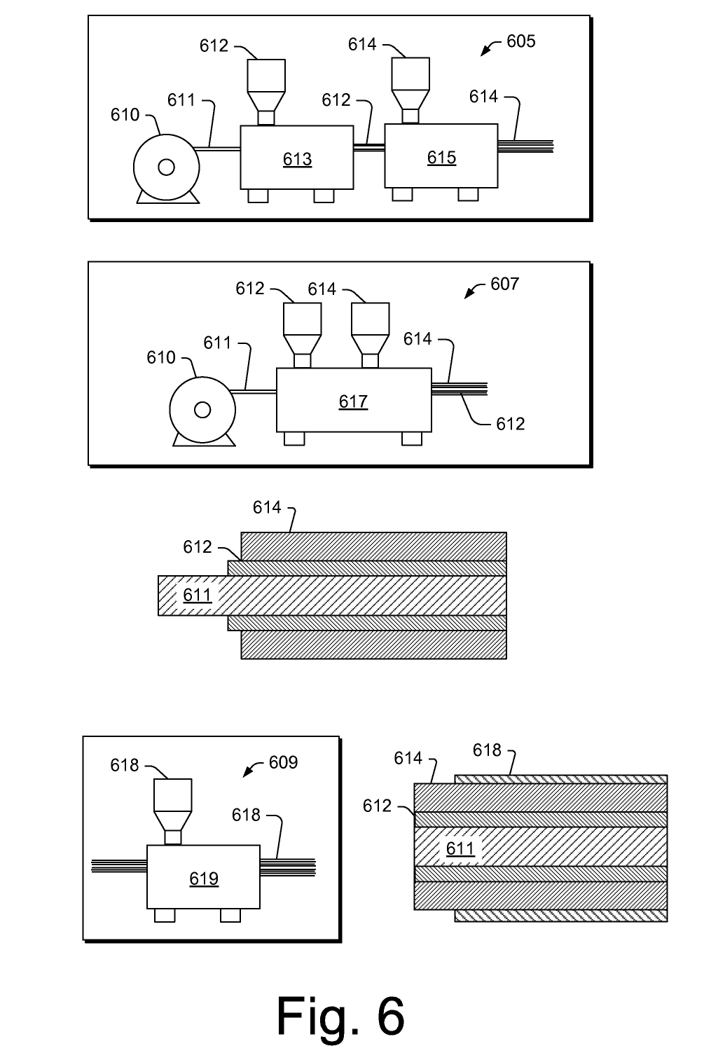

FIG. 6 shows example methods 605, 607 and 609 for extruding material as part of a cable manufacturing process. The method 605 includes providing a spool 610 with a conductor 611 carried thereon, providing material 612 for an extruder 613 and providing material 614 for an extruder 615. As shown, in the method 605, the conductor 611 is feed from the spool 610 to the extruder 613 which receives the material 612 (e.g., in a solid state), melts the material 612 and deposits it onto the conductor 611. Thereafter, the conductor 611 with the material 612 deposited thereon is feed to the extruder 615, which receives the material 614 (e.g., in a solid state), melts the material 614 and deposits it onto the material 612.

As to the method 607, an extruder 617 provides for co-extrusion of the materials 612 and 614 onto the conductor 611 as received from the spool 610. As mentioned, a co-extrusion process may include multiple extruder bores and a cross-head, die, dies, etc. to direct molten material onto a conveyed conductor (e.g., which may be bare or may have one or more layers deposited therein). As an example, an extrusion system may extrude multiple layers of material where at least one of the layers includes a composite material that include graphene nanosheets (e.g., consider graphene nanosheets in a polymer matrix).

As an example, the cable produced by the method 605 or the method 607 may be input to the method 609 for deposition of another layer of material thereon. For example, material 618 may be provided (e.g., in a solid state) to an extruder 619 that receives the cable produced by the method 605 or the method 607 where the extruder 619 melts the material 618 and deposits it onto the layer formed by the material 614. As noted, a delay may exist between the method 605 or the method 607 and the method 609, for example, to allow for some amount of hardening of at least the layer formed by the material 614 such that stripping of the material 618 may be more readily achieved for purposes of splicing, etc.

As an example, graphene nanosheets (e.g., or “nanoplatelets” or “nanoflakes”) may include structures that are nanosheet stacks of single-layer graphene (e.g., individual nanosheets). Such nanosheets may have a relatively high aspect ratio (e.g., greater than about 100 or more) and desirable physical properties. As to aspect ratio, for a nanosheet (e.g., or a few nanosheets), it is defined by a lateral dimension and a thickness dimension (e.g., thickness). As an example, a single layer of carbon atoms may be of a thickness of about 0.34 nanometers. As an example, a graphene nanosheet may be of the order of about 0.5 nanometers and, for example, a structure of several graphene nanosheets may be of the order of about 1 nanometer or more. As an example, a lateral dimension of a graphene nanosheet may be of the order of about 100 nanometers or more. As an example, a lateral dimension of a graphene nanosheet may be of the order of about a micron or more (e.g., about 1000 nanometers or more). As an example, a lateral dimension of a graphene nanosheet may be of the order of about 10 microns or more.

As an example, a cable may include platelet-like nanomaterial for reducing gas permeability in a host polymer matrix (e.g., as such platelets have demonstrated impermeable to various gases). As an example, a layer by layer assembly of graphene oxide (e.g., as a derivative produced by treating graphene with strong acid) and polymer multilayer thin film may reduce O₂ and CO₂ permeation.

As an example, a cable (e.g., and/or MLE) may include one or more substantially aligned graphene nanosheets/polymer composite structures that enhance gas barrier properties.

As an example, a graphene paper wrapping may be provided as a substitute for a lead-based (Pb) material. As an example, incorporation of substantially aligned graphene nanosheets in multiple components of a cable's structure may be achieved, for example, via high shear extrusion (e.g., where extrusion flow acts to align graphene nanosheets). For example, given an aspect ratio of about 1000 or more, graphene nanosheets may align during an extrusion process (e.g., consider alignment of graphene nanosheets as substantially parallel plates that may flow along streamlines in a direction of a lateral dimension).

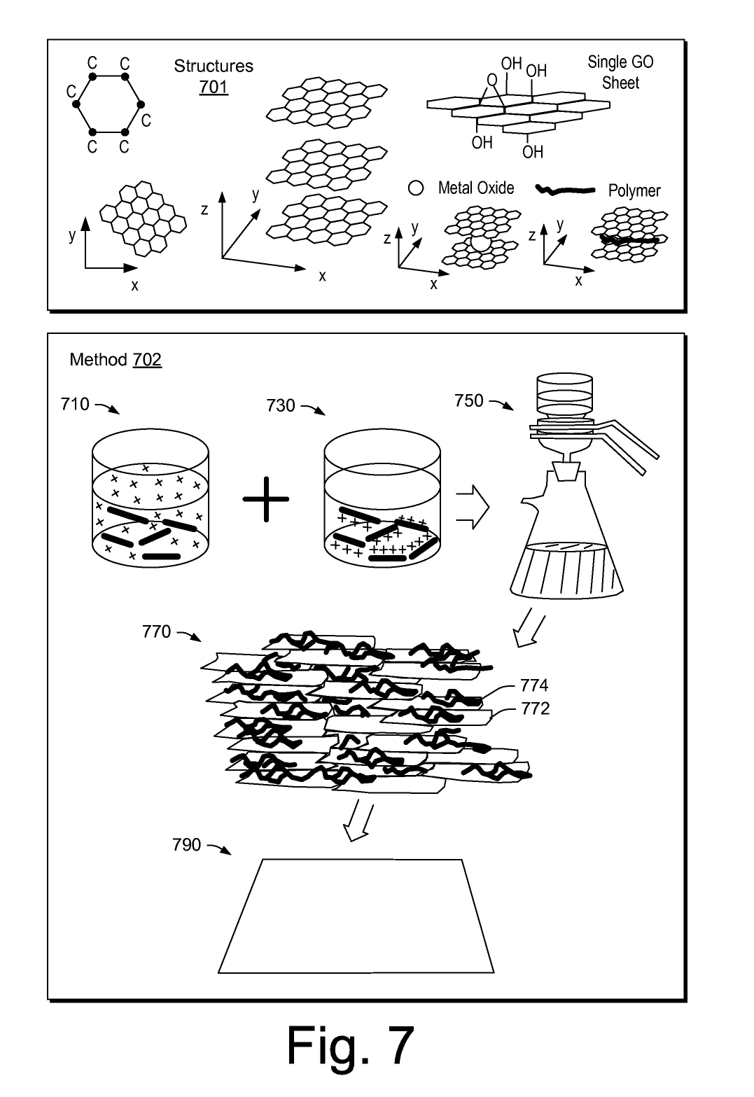

FIG. 7 shows examples of structures 701 and an example of a method 702, which is illustrated schematically as a method for making graphene paper.

While graphite is a three-dimensional carbon-based material made of layers of graphene, graphite oxide differs. By oxidation of graphite using one or more oxidizing agents (e.g., sulfuric acid, sodium nitrate, potassium permanganate, etc.), oxygenated functionalities can be introduced in a graphite structure (e.g., hydroxyl, epoxide, etc.) that can expand layer separation and impart hydrophilicity. The imparted hydrophilicity can allow for exfoliation of graphite oxide in water (e.g., via sonication assist, etc.) to produce single or few layer graphene, which may be referred to as graphene oxide (GO); noting that one or more other techniques for exfoliation may be implemented, additionally or alternatively (e.g., other mechanical, chemical, thermal, etc.). Thus, a difference between graphite oxide and graphene oxide can be the number of layers. For example, a dispersion of graphene oxide may include structures of a few layers or less (e.g., flakes and monolayer flakes); whereas, structures of graphite oxide include more layers. As an example, graphene oxide (GO) may be reduced to form reduced graphene oxide (rGO). As an example, graphene oxide may include surface charge, which may be negative (e.g., consider presence of oxygen), depend on factors such as pH, etc.

As an example, a material may include graphene and a metal oxide bound via hydrogen bonds to the graphene. As an example, a material may include graphene and one or more polymers that may be capable of forming hydrogen bonds and/or other bonds to the graphene. As an example, a material may include graphene, oxide(s) and one or more polymers. As an example, a material may include graphene as graphene oxide (GO).

In FIG. 7, the structures 701 include graphene where, for example, carbon atoms may be arranged in a hexagonal manner, due to sp² bonding, as a crystalline allotrope of carbon (e.g., as a large aromatic molecule). Graphene may be described as being a one-atom thick layer of graphite and may be a basic structural element of carbon allotropes such as, for example, graphite, charcoal, carbon nanotubes and fullerenes.

As an example, a nanosheet (e.g., or nanoplatelet) may be defined as including a two-dimensional nanostructure that may be characterized in part by a thickness between a lower surface and an upper surface of the nanostructure where the thickness is less than about 100 nanometers. As an example, a graphene nanosheet may include a thickness of the order of about 0.34 nm (e.g., consider a single layer of carbon atoms with hexagonal lattices). As mentioned, a nanosheet may be defined in part by an aspect ratio. As an example, a graphene nanosheet may include an aspect ratio of about 100 or more. As an example, graphene nanosheets that include, on average, an aspect ratio of the order of about 100 or more (e.g., optionally of about 1000 or more) may be used to form one or more types of composite materials. As an example, a larger dimension of a graphene nanosheet (e.g., that may define in part an aspect ratio) may be, for example, of the order of about 100 nanometers or more. As an example, a larger dimension of a graphene nanosheet (e.g., that may define in part an aspect ratio) may be, for example, of the order of about 1 micron or more. As an example, a larger dimension of a graphene nanosheet (e.g., that may define in part an aspect ratio) may be, for example, of the order of about 10 microns or more. As an example, graphene nanosheets may be made and/or provided in a range of dimensions and/or aspect ratios.

As illustrated the structures 701 may include a layer of graphene or layers of graphene, which may be described, for example, with respect to a Cartesian coordinate system (x, y, z). As an example, a layer may be bonded to another layer, for example, via interactions that may involve epoxide and hydroxyl groups. As an example, one or more layers may include one or more of epoxide, carbonyl (C═O), hydroxyl (—OH), and phenol groups, which may optionally participate in bond formation. For example, see an approximate representation of a single graphene sheet in the structures 701, which includes various oxygen groups (e.g., a GO sheet).

As an example, layers of graphene may be bonded via one or more metal oxides and hydrogen, for example, magnesium oxide may bind to graphene via hydrogen atoms; and/or layers of graphene may be bonded via one or more polymers and hydrogen (e.g., and/or other group).

As an example, a material may exhibit one or more regions that deviate from planarity (e.g., a buckling like structure). As an example, a material may include disorder and/or irregular packing of layers.

As an example, a material may be manufactured to include a paper-like form. As an example, a method may include providing dispersed, oxidized and chemically processed graphite in water where few and/or monolayer flakes may form a sheet that includes hydrogen bonds. For example, consider a sheet of graphene oxide, which may, for example, have a tensile modulus of the order of tens of GPa.

As an example, chemical properties may be selected via one or more functional groups that may be attached to graphene sheets. For example, one or more functional groups may participate in polymerization and/or one or more other reactions. As an example, graphene may be hydrophobic and relatively impermeable to gas and liquid (e.g., vacuum-tight). As an example, graphene may be used to form a graphene oxide-based capillary membrane, which may be selectively permeable to certain molecules (e.g., water as a liquid, water vapor, etc.).

As an example, a material may be formed that is relatively impermeable to gas. As an example, a material may include an aligned composite structure of polymer and graphene nanoplatelets (e.g., nanosheets) that exhibits gas barrier properties. Such a material may exhibit, for example, chemical resistance and/or heat resistance. As an example, a material that includes graphene (e.g., optionally as graphene paper) may be laminated on at least one side with a polymer or polymers, for example, to enhance mechanical and/or other properties. As an example, a material may be laminated to form a tape.

As an example, the method 702 may include flow-directed filtering (e.g., flow-direction filtration). As an example, the method 702 may include making an aligned graphene and polymer composite sheet. In such an example, flow directed self-assembly of graphene nanoplatelets and polymer may form such a sheet.

As shown, the method 702 can include dispersing graphene nanoplatelets (see, e.g., black line segments) in a solution that includes water and a water soluble binder polymer (see, e.g., “+”) to form a mixture 710. As an example, such a mixture may be formed with a desired graphene to polymer weight ratio (e.g., about 10 to 1 in weight). As an example, the binder polymer may be or include a cationic binder polymer such as, for example, polyethyleneimine (PEI), poly(dimethyldiallylammonium chloride) (PDAC), etc.

PEI (e.g., polyethyleneimine or polyaziridine) can include repeating units with amine groups and aliphatic CH₂CH₂ spacers. As an example, linear PEIs may be formed of secondary amines, in contrast to branched PEIs which can include, for example, primary, secondary and tertiary amino groups.

PDAC (e.g., poly(dimethyldiallylammonium chloride) or polydiallyldimethylammonium chloride) can be of a molecular weight, for example, in a range of the order of about hundreds of thousands of grams per mole or more. PDAC may be provided as, for example, a liquid concentrate (e.g., with a solids level in a range of the order of about 10 percent or more).

As illustrated in FIG. 7, the method 702 can include absorbing the binder polymer to surfaces of the electron-rich graphene nanoplatelets by electrostatic attraction 730 (e.g., consider nanoplatelets with oxygen, oxygen groups, etc.). Given the attraction between the graphene nanoplatelets and the binder polymer, as illustrated, water may be removed, for example, by subjecting the mixture to vacuum filtration 750. In such an example, a film 770 may be formed that includes the nanoplatelets 772 and the polymer 774. In FIG. 7, the film 770 is illustrated as an enlarged portion of a film 790.

As an example, the method 702 may include filtering in a controlled manner by vacuum to remove water and form an aligned polymer functionalized graphene film. The degree of alignment of graphene/polymer film may be enhanced, for example, via applying a compressive load to remove trapped gas inside the film.

As an example, polymer may reside at gaps of graphene nanosheets, which may provide for formation of alternating layers of graphene and polymer. As an example, alignment of graphene nanosheets (e.g., or nanoplatelets) may create a tortuous path that may hinder transport of gas (e.g., hinder diffusion of gas, convection of gas, etc.).

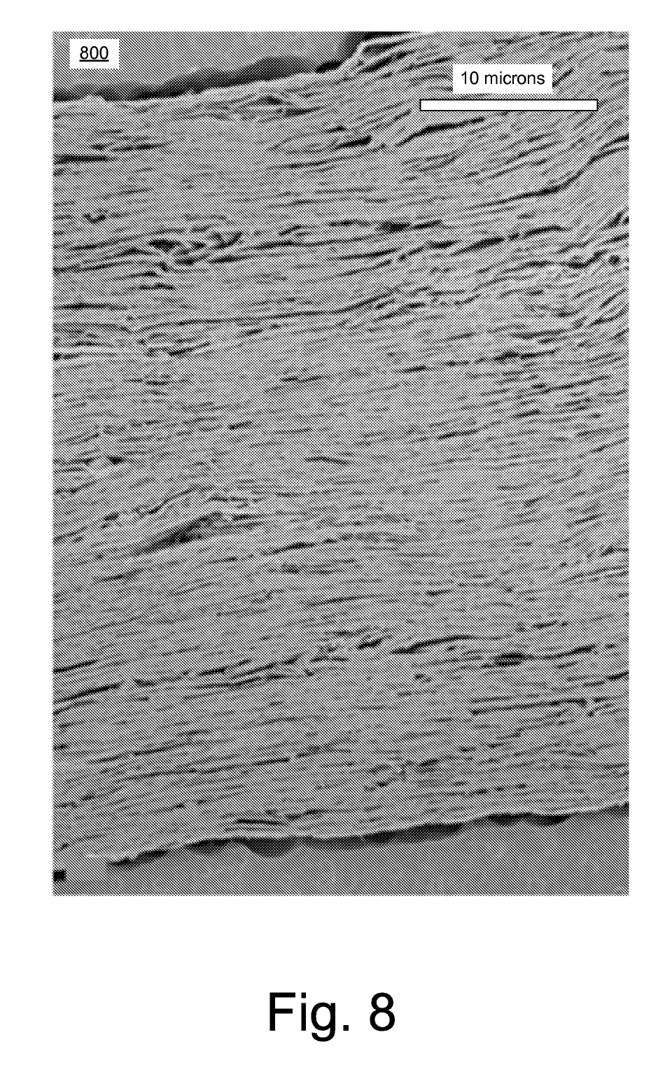

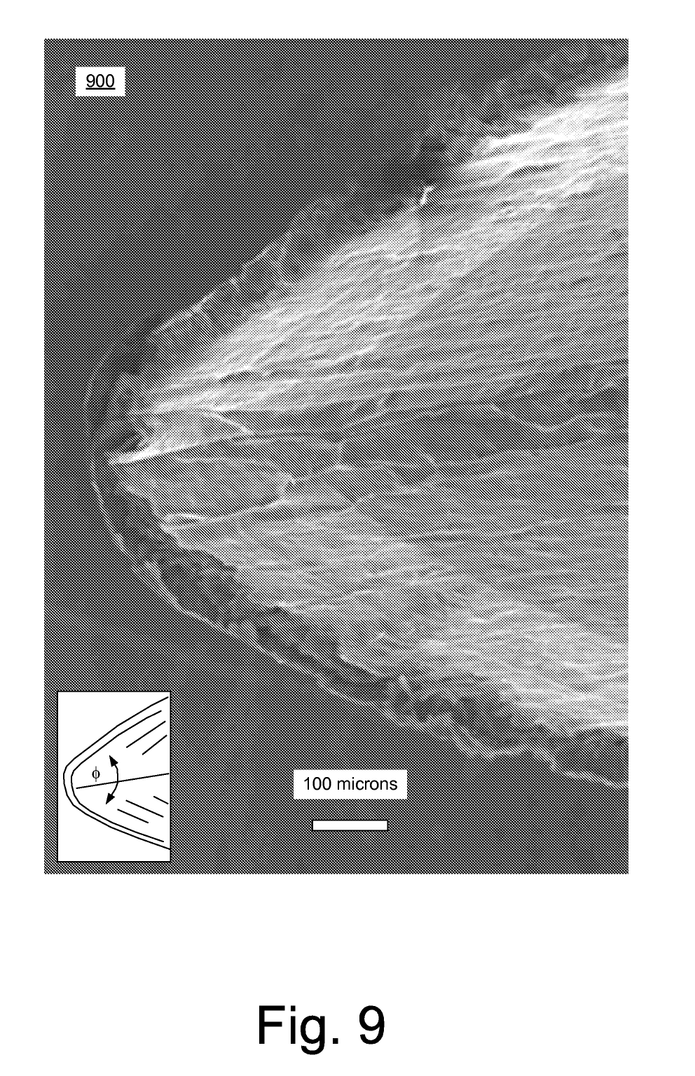

FIG. 8 shows an example of a scanning electron microscopic image 800, as a cross section of a layered composite structure (e.g., per the method 702 of FIG. 7). The image 800 shows very closely packed layered structures. Depending on the compaction of the layered structures, as an example, density of such a composite may be as high as about 1.8 g/cm³ (e.g., akin to that of bulk graphite which indicates its high packing density). Such a paper-like structure can be flexible and able to bend to relatively large angles without rupture (see, e.g., FIG. 9).

FIG. 9 shows an example of an image 900 of microscopic structure of graphene paper under bending (see, e.g., inset graphic with a bending angle φ) where the thickness of the paper is about 0.003 inches (e.g., about 0.076 mm or about 76,000 nanometers). The thickness of individual graphene paper may depend on concentration of graphene nanosheets, polymer binder in solution as well as, for example, compaction force. As an example, multiple layers of graphene paper may be stacked to build up to a desired thickness; optionally at different angles of alignment (e.g., angles of alignment in respective planes).

As an example, to preserve and/or increase mechanical integrity of graphene paper, laminates of graphene paper/PEEK, polyimide, PFA, PTFE (including ePTFE) may be constructed with an adhesive to allow, for example, for fusion sheet-to-sheet or sheet-to-laminate to create a continuous, cohesive layer.

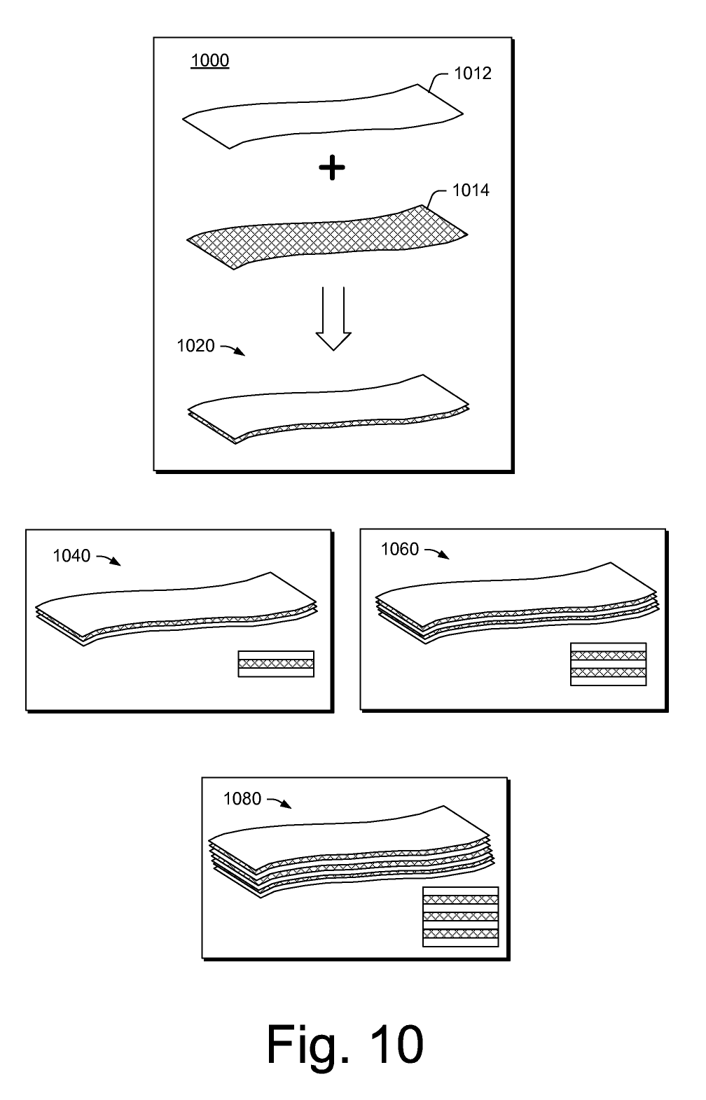

FIG. 10 shows an example of a schematic 1000 for creating graphene paper/polymer laminates by fusing graphene into polymer tape, for example, by using an adhesive promoter under high temperature treatment. As shown, a polymeric material 1012 may be bonded to a graphene material 1014 to form a composite material. FIG. 10 also illustrates examples of various arrangements 1040, 1060 and 1080 as to layering. For example, the arrangement 1040 may be an ABA arrangement where A is the polymeric material 1012 and B is the graphene material 1014, the arrangement 1060 may be an ABABA arrangement where A is the polymeric material 1012 and B is the graphene material 1014, and the arrangement 1080 may be an ABABABA arrangement where A is the polymeric material 1012 and B is the graphene material 1014. As an example, the polymeric material 1012 may be or include PEEK. As an example, the polymeric material 1012 may be or include polyimide. As an example, the polymeric material 1012 may be or include perfluoroalkoxy alkanes (PFA). As an example, the polymeric material 1012 may be or include PTFE, optionally as expanded PTFE (e.g., ePTFE). As an example, an arrangement may include two or more polymeric materials, for example, consider two or more of PEEK, polyimide, PFA, PTFE, etc.

As an example, an approach may include dispersing graphene nanosheets in various components in a cable by high shear extrusion. As an example, a power cable with a voltage rating greater than about 5 kV may benefit from conductor and insulation shield as stress control layers. As an example, graphene nanosheets, with high aspect ratio (e.g., on average of the order of 100 or more and optionally on average of the order of 1000 or more) and superior electrical properties, may be used as a substitute to carbon black used in an EPDM elastomer based semiconductor layers.

As an example, during extrusion, graphene nanosheets may tend to re-orient along the flow of polymer. As an example, a smaller extruded thickness may result in a higher shear rate and shear stress (e.g., consider a die with parallel plates the define a thickness through which extruded material passes). A highly aligned graphene semiconductor layer may be beneficial for reducing gas diffusion through a layer. For example, to maintain a desired level of graphene orientation, multiple layers of highly filled graphene compound (e.g., each of about 10 mils in thickness) may be extruded over insulation, for example, to substitute for both an insulation shield and lead (Pb) in a cable without compromising electrical properties.

As an example, an outer jacket layer, which may not ordinarily provide good gas barrier properties, may be doped with graphene nanosheets, for example, for blocking gases and, for example, improving overall mechanical strength and wear resistance of the cable. While alignment of individual graphene nanosheets might not be as good due to smaller shear stress during extrusion as a result of a thicker wall, it may potentially reduce swelling, increase life of the jacket as well as provide another gas barrier layer on the outside.

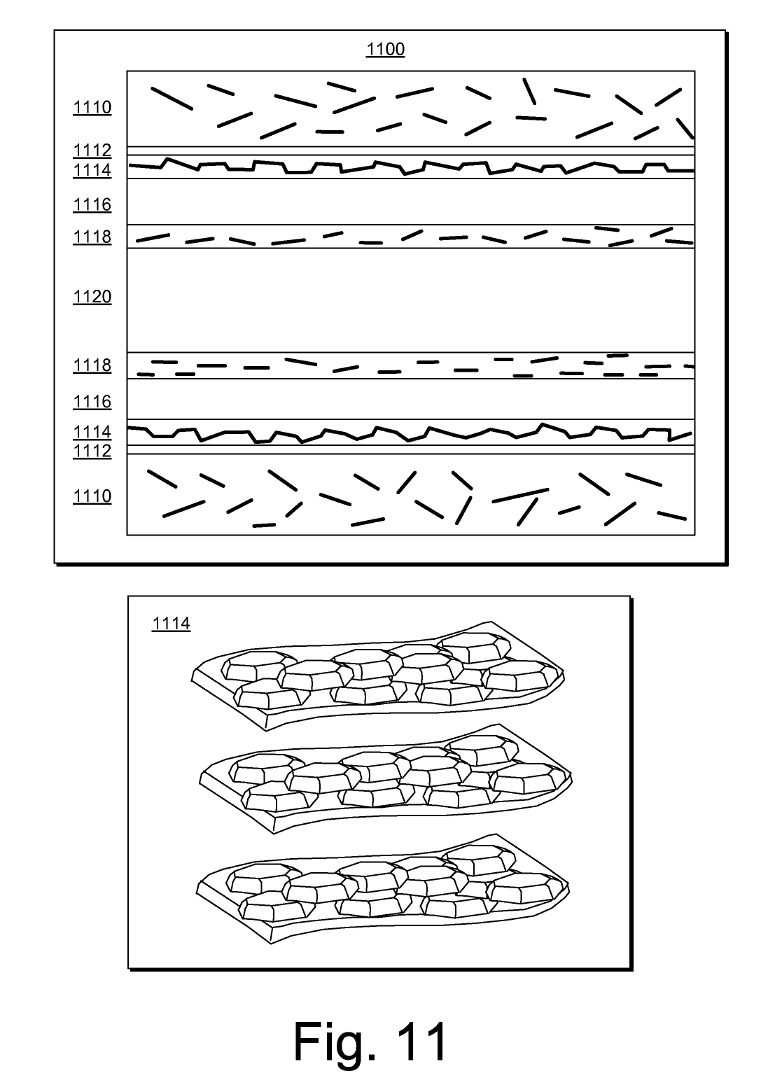

FIG. 11 shows a schematic representation of an example of a cross sectional view of a cable 1100 from outside to inside (e.g., jacket, tape and braid, gas barrier, insulation, conductor shield, and conductor) where black lines indicate different levels of graphene alignment in each layer. In such an example, a gas barrier layer may include multiple extruded layers of graphene/thermoplastic composites. In the example of FIG. 11, the cable 1100 includes a jacket 1110, a tape and braid layer 1112, a gas barrier layer 1114, an insulation layer 1116, a shield layer 1118 and a conductor 1120.

As an example, an extruded graphene barrier may include a composite as a filled thermoplastic utilizing a matrix of poly-aryl ether ketone (PEK, PEEK, PEKEKK), melt extrudable fluoropolymer (ethylene tetrafluoroethylene (ETFE), polyvinylidene fluoride (PVDF), fluorinated ethylene propylene (FEP), PFA, ethyl cyanoacrylate (ECA)) or other suitable material with sufficient thermal and fluid resistance. Such an approach may provide suitable damage resistance provided by high mechanical strength of a graphene composite. Graphene alignment and gas blocking may benefit from extrusion as a thin layer. As an example, multilayer extrusion dies that may be capable of applying from about 10 to about 1000 layers of individual thicknesses in the nanometer to micrometer range may be used for imparting beneficial barrier, mechanical, and impact resistant properties. Such a layer may accomplish gas and fluid blocking abilities that may be suitable to use the layer as a substitute to a lead (Pb) layer. As an example, a graphene composite layer (e.g., including nanostructures) may be formed thinner than a lead (Pb) layer (e.g., lead sheath thickness may be about 0.040 inch to about 0.060 inch; about 1 mm to about 1.5 mm), which may help to reduce cable weight. As an example, a graphene composite material may have a density at least about five times less than a lead (Pb) sheath of comparable thickness.

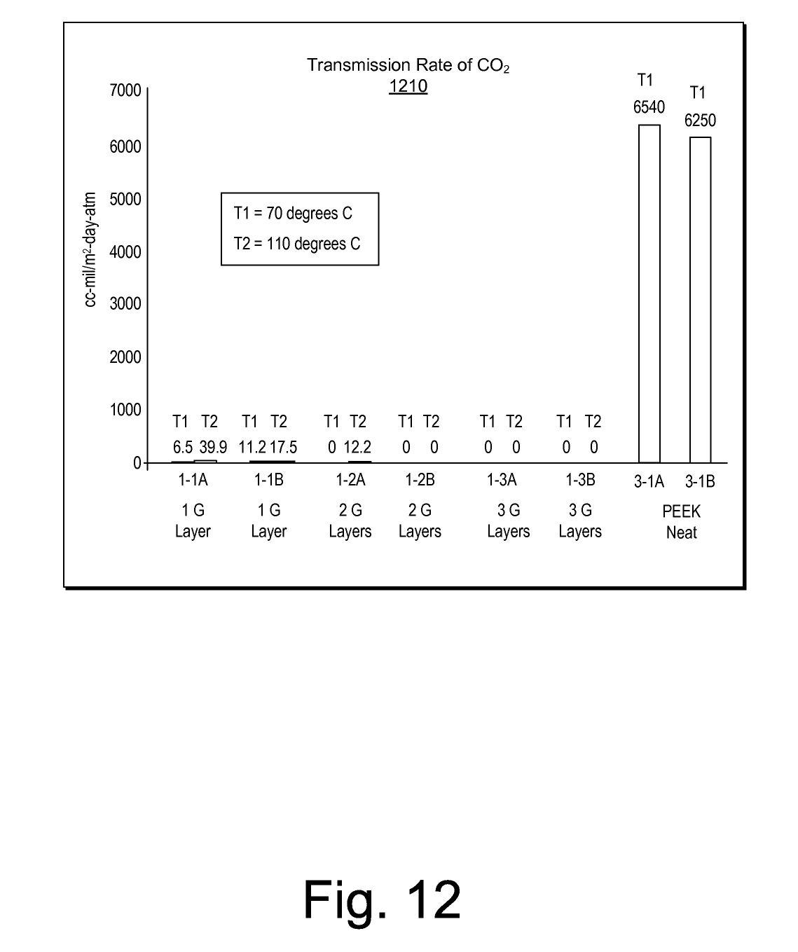

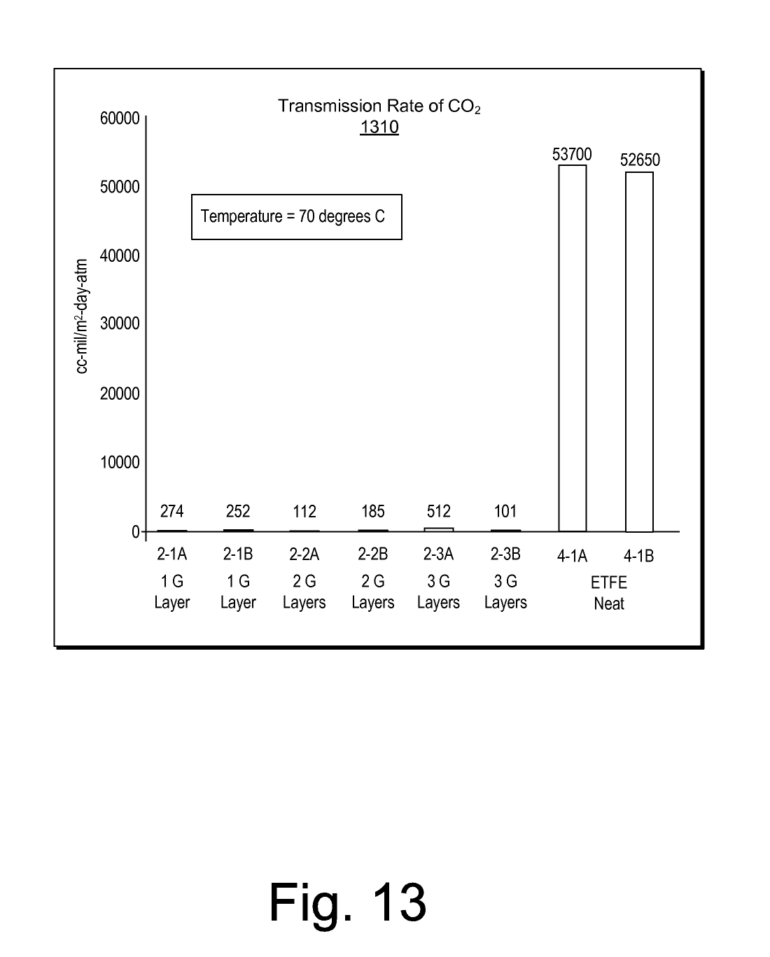

FIG. 12 shows an example plot 1210 of transmission rates of CO₂ with respect to various materials and FIG. 13 shows an example plot 1310 of transmission rates of CO₂ with respect to various materials. The data in the plots 1210 and 1310 indicate reduction in gas transmission for polymer/graphene laminated tape structures.

The data in the plots 1210 and 1310 correspond to 100 percent CO₂ gas permeation trials for various materials. For example, composite materials with arrangements ABA (1 G layer), ABABA (2 G layers) and ABABABA (3 G layers) were subject to carbon dioxide where A represents PEEK film (the plot 1210 of FIG. 12) or ETFE film (the plot 1310 of FIG. 13) and B represents a graphene sheet (referred to as “G”). Thus, the ABA structure includes one layer of graphene (e.g., as a sheet), the ABABA structure includes two layers of graphene (e.g., each as a sheet), and the ABABABA structure includes three layers of graphene (e.g., each as a sheet).

In the plot 1210, temperatures are also indicated (see, e.g., T1=70 degrees C. and T1=110 degrees C.). The data in the plot 1310 correspond to a temperature of approximately 70 degrees C. The data in the plot 1210 indicate that the CO₂ gas transmission rates at the indicated temperatures for PEEK/graphene are orders of magnitude less than the CO₂ transmission rates through neat polymer films (see 3-1A and 3-1B). The data in the plot 1310 indicate that the CO₂ gas transmission rates at the indicated temperatures for ETFE/graphene are orders of magnitude less than the CO₂ transmission rates through neat polymer films (see 4-1A and 4-1B).

Stiffness of a laminated tape may be adjusted at least in part by film thickness. The individual PEEK films used for gas transmission trials had a thickness of about 0.002 inch (e.g., about 0.05 mm) while the individual graphene sheets used for the gas transmission trials had a thickness of about 0.003 inch (e.g., about 0.076 mm). Thus, the total thickness was about 0.007 inch (e.g., about 0.18 mm) for an ABA structure. As an example, individual film thickness may be selected based on one or more factors. As an example, smaller thicknesses of individual films/sheets may allow for an increase the number of graphene layers, which may, in turn, increase resistance to gas transport. As an example, a material may provide for a reduction in gas transmission without compromising flexibility of a polymer/graphene laminate, composite tape.

As an example, a structure may include layers A, B and C (e.g., and optionally D, etc.). For example, a laminate configuration may include a fluoroplastic film on the outside for chemical resistance and a graphene sheet/PEEK/polyimide structure on the inside (e.g., with different thicknesses of individual layers). In such an example, the laminate configuration may be that of a composite tape.

As an example, a method can include forming tape. In such an example, the tape may be a laminated structure that can be wrapped around a conductor, optionally directly or indirectly (e.g., with intervening material). As an example, a method can include taping. Such a method may include spiraling tape about a cylindrical body that includes at least one conductor. In such an example, overlap may be used to create “doubled” portions. As an example, a method can include taping to form a first spiral of tape and taping to form a second spiral of tape where, for example, the first spiral and the second spiral may be in the same direction or in opposite directions (e.g., right hand and left hand, clockwise and counter-clockwise, etc.).

As an example, a roll to roll high temperature laminator may be used to laminate a desired number of layers into a continuous film. In such an example, the film may be slit into a desired width or widths to form tape(s). During a slitting process, edges of the film may be sealed to prevent exposing one or more inner graphene sheets of the film to the environment (e.g., environmental conditions). As an example, laser and/or electron beam heating may be applied to seal off edges of slit film (e.g., tape) during a slitting process. As an example, tape may be wrapped around an insulated conductor, for example, at a particular lap ratio (e.g., consider lap at about 55 percent or more). As an example, a method may include heat fusing a polymer layer of tape to form a “seamless” tape layer. As an example, heat fusing may involve one or more ovens through which a cable may pass and/or be placed inside. As an example, heat fusing may involve one or more types of heat fusion technology. For example, consider localized heating via one or more lasers beams, one or more electron beams, etc. As an example, a tape that includes at least one layer of graphene (e.g., as a graphene sheet) may be suitable for use in repair and/or splicing a cable, a wire, etc. For example, a cable formed via tape may be repaired and/or spliced using the tape or different tape.

As an example, a lead (Pb)-free power cable may be suitable for use for an intervention in a constrained well such as, for example, a subsea alternate deployed ESP application where lead (Pb) use may be prohibited as to a power cable.

As an example, a non-lead (Pb), gas impermeable composite material that includes polymer and one or more aligned graphene sheets can reduce weight of a cable as well as providing a H₂S and/or CO₂ resistant properties that, for example, act as a barrier layer with respect to primary insulation (e.g., hinder gas migration from an environment to the primary insulation). Such a non-lead (Pb), gas impermeable composite material may reduce explosive gas decompression in situations where, for example, there are substantial temperature and/or pressure swings in a downhole application. As an example, a cable may be suitable for use in a “cable deployed” ESP application (a CDESP application).

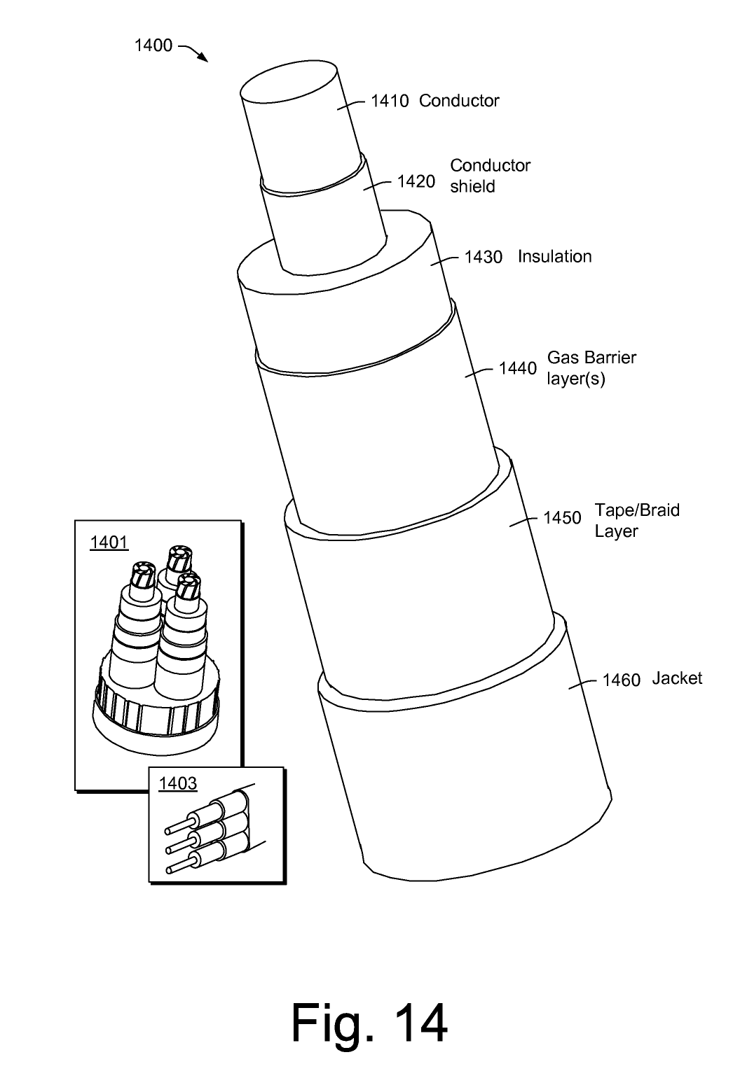

FIG. 14 shows a schematic drawing of an example of a lead-free cable 1400 (e.g., no to minimal Pb), for example, with a graphene filled gas barrier in the form of a paper structure tape wrapping around insulation or, for example, with graphene filled composites by extrusion. As an example, a cable may include tape and/or extruded graphene composite material, for example, where such tape and/or extruded materials impart beneficial gas barrier properties.

As shown in FIG. 14, the cable 1400 may be a single conductor cable or a multi-conductor cable such as, for example, a round three conductor cable 1401, a flat three conductor cable 1403, etc.

As shown, the cable 1400 includes a conductor 1410, a conductor shield layer 1420, an insulation layer 1430, one or more gas barrier layers 1440, one or more tape and/or braid layers 1450 and a jacket 1460.

As an example, the conductor shield layer 1420 may be or include graphene, optionally as a laminated composite material that includes polymer and one or more graphene sheets.

As an example, the one or more gas barrier layers 1440 may be or include graphene, optionally as graphene paper and/or a laminated composite material that includes polymer and one or more graphene sheets.

As an example, the jacket 1460 may be a relatively smooth polymeric jacket. As an example, the jacket 1460 may be a metallic jacket. As an example, the cable 1400 may include one or more layers of armor. As an example, the cable 1400 may include one or more metallic strands that form one or more strength members. In such an example, the one or more strength members may be surrounded by a layer or layers of material that include graphene. As an example, a cable may include one or more metallic strands that form one or more strength members that are disposed in a polymeric material with a relatively smooth exterior surface.

As an example, the cable 1400 may be a power cable that includes the conductor 1410 and at least one layer disposed radially about the conductor 1410 where the layer includes graphene nanosheets in a polymeric matrix (see, e.g., the layers 1420 and 1440). As an example, such a layer may hinder gas transport. For example, such a layer may have properties that can be characterized via gas transmission (see, e.g., the plots 1210 and 1310 of FIGS. 12 and 13). Where a layer has a relatively low gas transmission rate, the layer may be referred to as a gas barrier layer. For example, one or more of the composite materials for which gas transmission rate data are shown in the plots 1210 and 1310 may be suitable for forming a layer that may be referred to as a gas barrier layer, particularly when compared to gas transmission rates of the “neat” materials.

As an example, graphene “paper” may be a paper-like material with closely packed and highly aligned graphene nanosheets and polymer binder. As an example, such a paper may be used as a primary gas barrier in place of a lead (Pb)-based barrier. As an example, graphene paper may be laminated with one or more high temperature polymers for mechanical robustness (e.g., for use in a taping process, etc.).

As an example, graphene may be incorporated in different cable components: graphene nanosheets of desired loading was dispersed into the an elastomer or thermoplastic compounds and extruded as a layer of conductor shield, as well as extruding multiple layers over insulation to build up the desired layer thickness followed by jacket. In such an example, multiple layers of highly aligned graphene filled compounds may each contribute to reduction of gas permeation.

As an example, graphene nanosheets may be provided in one or more types of forms and used in construction of power cables and/or motor lead extensions (e.g., where high gas concentration may be a concern). Various types of cables may benefit from physical properties of graphene nanosheets and reduced gas permeation, for example, which may increase average life of power cable products and MLEs.

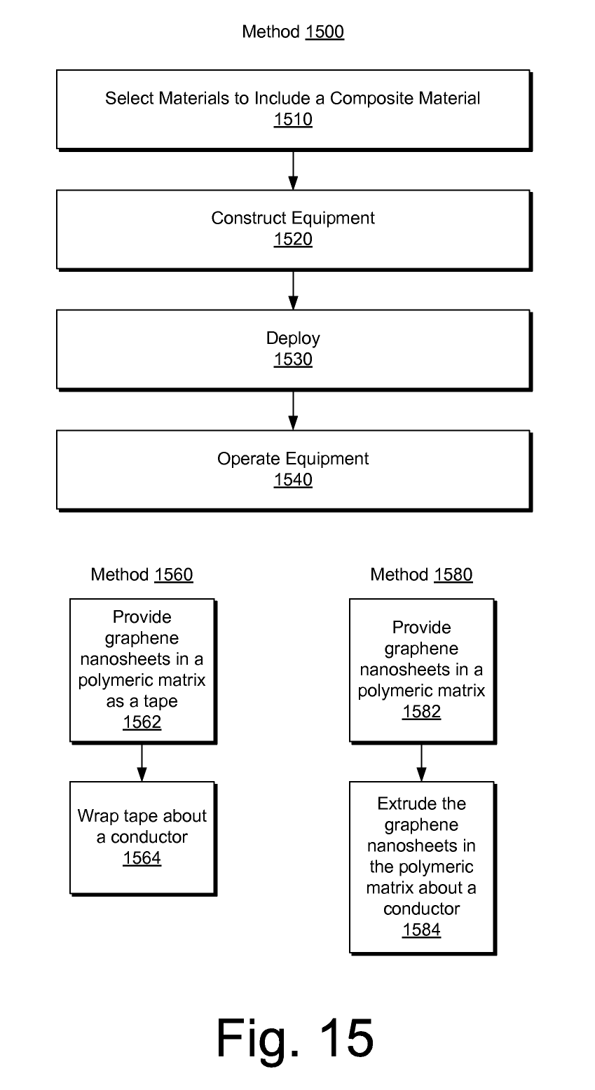

FIG. 15 shows examples of methods 1500, 1560 and 1580. As shown, the method 1500 includes a selection block 1510 for selecting materials to include a composite material where, for example, the materials include graphene capable of forming nanosheet structures and/or graphene nanosheet structures (e.g., graphene nanosheets, etc.); a construction block 1520 for constructing equipment; a deployment block 1530 for deploying the equipment; and an operation block 1540 for operating the equipment. In such an example, the equipment may be or include one or more cables and/or one or more MLEs.

As shown, the method 1560 includes a provision block 1562 for providing graphene nanosheets in a polymeric matrix as a tape; and a wrap block 1564 for wrapping the tape about a conductor. As shown, the method 1580 includes a provision block 1582 for providing graphene nanosheets in a polymeric matrix; and an extrusion block 1584 for extruding the graphene nanosheets in the polymeric matrix about a conductor. As an example, the selection block 1510 of the method 1510 may include selecting graphene nanosheets and one or more polymeric materials, for example, per the blocks 1562 and 1582, respectively. As an example, the construction block 1520 of the method 1500 may include wrapping and/or extruding, for example, per the blocks 1564 and 1584, respectively.

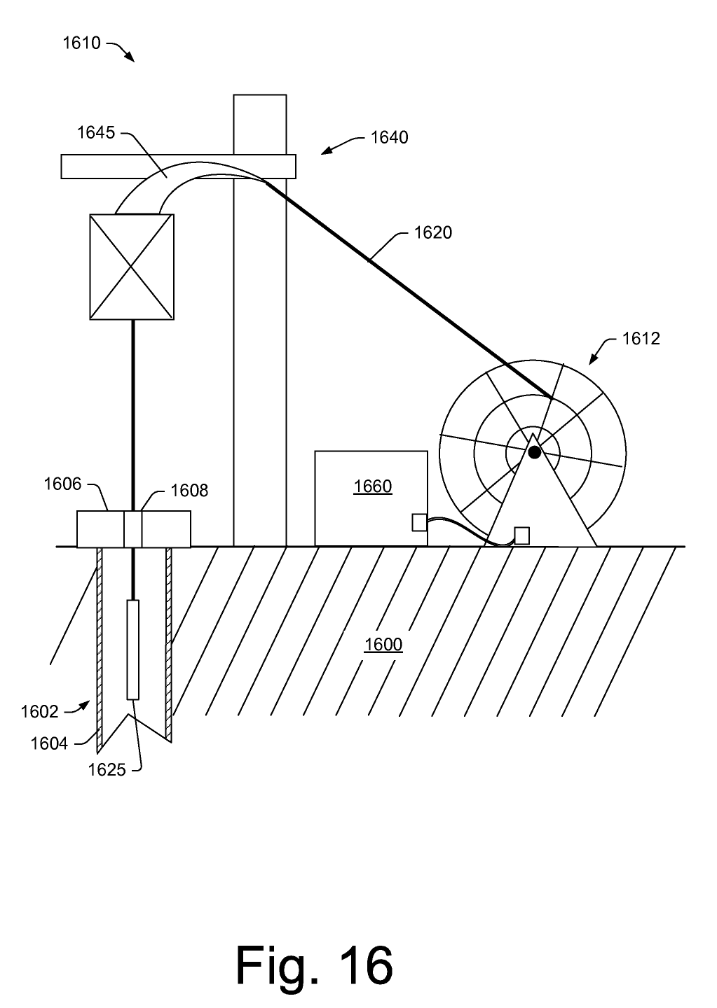

FIG. 16 shows an example of a geologic environment 1600 and a system 1610 positioned with respect to the geologic environment 1600. As shown, the geologic environment 1600 may include at least one bore 1602, which may include casing 1604 and well head equipment 1606, which may include a sealable fitting 1608 that may form a seal about a cable 1620. In the example of FIG. 16, the system 1610 may include a reel 1612 for deploying equipment 1625 via the cable 1620. As an example, the equipment 1625 may be a pump such as an ESP. As an example, the system 1610 may include a structure 1640 that may carry a mechanism such as a gooseneck 1645 that may function to transition the cable 1620 from the reel 1612 to a downward direction for positioning in the bore 1602.

As an example, the cable 1620 may include one or more conductive wires, for example, to carry power, signals, etc. For example, one or more wires may operatively couple to the equipment 1625 for purposes of powering the equipment 1625 and optionally one or more sensors. As shown in the example of FIG. 16, a unit 1660 may include circuitry that may be electrically coupled to the equipment 1625. As an example, the cable 1620 may include or carry one or more wires and/or other communication equipment (e.g., fiber optics, rely circuitry, wireless circuitry, etc.) that may be operatively coupled to the equipment 1625. As an example, the unit 1660 may process information transmitted by one or more sensors, for example, as operatively coupled to or as part of the equipment 1625. As an example, the unit 1660 may include one or more controllers for controlling, for example, operation of one or more components of the system 1610 (e.g., the reel 1612, etc.). As an example, the unit 1660 may include circuitry to control depth/distance of deployment of the equipment 1625.

In the example of FIG. 16, the weight of the equipment 1625 may be supported by the cable 1620. As an example, the cable 1620 may support the weight of the equipment 1625 and its own weight, for example, to deploy, position, retrieve the equipment 1625.

In the example of FIG. 16, the cable 1620 may include graphene and may optionally be free or substantially free of lead (Pb). In such an example, the graphene may be in sheet form, optionally as a laminated composite material, for example, laminated with one or more polymers (e.g., consider a laminated structure of graphene sheets and polymer films). In such an example, the graphene may impart tensile strength that may help support the weight of the cable 1620 and the weight of the equipment 1625 as operatively coupled to the cable 1620. As an example, the cable 1620 may have a relatively smooth outer surface, which may be a polymeric surface. In such an example, the surface may facilitate deployment and/or sealability, for example, to form a seal about the cable 1620 (e.g., at a wellhead and/or at one or more other locations).

As an example, a power cable and/or a motor lead extension can include a conductor; and a layer disposed radially about the conductor where the layer includes graphene nanosheets in a polymeric matrix (e.g., optionally including one or more other materials). As an example, a layer may be an extruded layer, a tape layer or other type of layer. As an example, a power cable and/or a MLE may not include a lead-based barrier layer.

As an example, a power cable may include at least one motor lead extension (MLE). In such an example, the MLE may include a conductor and a layer disposed radially about the conductor where the layer includes graphene nanosheets in a polymeric matrix.

As an example, a power cable may include three conductors where each of the conductors has an associated layer disposed radially thereabout that includes graphene nanosheets in a polymeric matrix. As an example, a power cable can include at least three conductors for delivery of multiphase power directly or indirectly to a motor of an electric submersible pump.

As an example, a power cable can include a conductor and a layer disposed radially about the conductor where the layer includes graphene nanosheets in a polymeric matrix and where the polymeric matrix includes polyether ether ketone (PEEK), ethylene tetrafluoroethylene (ETFE) or PEEK and ETFE.

As an example, a power cable can include a conductor and a layer disposed radially about the conductor where the layer includes graphene nanosheets in a polymeric matrix and where the layer includes properties that may be characterized by a carbon dioxide gas transmission rate that is at least one order of magnitude less than that of the polymeric material without the graphene nanosheets.

As an example, a method can include providing graphene nanosheets in a polymeric matrix as a tape; and wrapping the tape about a conductor. In such an example, the conductor may be a conductor of a power cable or a motor lead extension. As an example, wrapping may include wrapping tape about a layer disposed about a conductor. As an example, a method may include tape that includes a polymeric matrix that includes polyether ether ketone, ethylene tetrafluoroethylene or polyether ether ketone and ethylene tetrafluoroethylene.

As an example, a method can include providing graphene nanosheets in a polymeric matrix; and extruding the graphene nanosheets in the polymeric matrix about a conductor. In such an example, the conductor may be a conductor of a power cable or a motor lead extension. As an example, extruding may include extruding graphene nanosheets in a polymeric matrix about a layer disposed about a conductor. As an example, extruding may include co-extruding, for example, where more than a layer is extruded. As an example, a method can include extruding where the extruding aligns the graphene nanosheets. For example, forces associated with flowing a molten material from a die under pressure of an extruder screw, etc. may cause graphene nanosheets to align (e.g., with respect to streamlines of the flowing molten material). In such an example, a flowing molten material may be flowing molten polymeric material with graphene nanosheets therein (e.g., as a mixture). For example, approximately nano-sized graphene may have an aspect ratio (e.g., defined by a lateral dimension and a thickness) where the nano-sized graphene tends to align with streamlines such that a lateral dimension becomes approximately parallel to streamlines. In such an example, flow of material may act to turn nano-sized particles (e.g., orient or align nano-sized particles) that may have a lateral dimension facing flow (e.g., a plate face) to have a shorter dimension facing flow (e.g., a plate edge to minimize drag, etc.). As an example, a flow regime may be selected that aims to achieve a desired amount of alignment of nano-sized particles (e.g., from lesser aligned to more aligned). As an example, temperature, pressure, flow rate, polymer properties (e.g., viscosity, chain length, charge, etc.) may be selected to achieve a desired amount of alignment of nano-sized particles in a polymeric matrix.

As an example, a composite material may be in a laminated form, a matrix form or other form. As an example, a composite material may include various forms, for example, consider a material that may include laminated layers where a layer or layers therein may be of a matrix form, etc. As an example, an extruder system may include separate bores where each of the bores may provide for extrusion of a material via a die or dies. As an example, an extruder system may be configured to extrude a composite material as a matrix and/or to extrude a composite material as laminated layers. As an example, extruders may extrude materials at different angles, for example, to form laminated layers where alignment of graphene in each of a graphene layer may differ. As an example, a direction of flow of material may act to align graphene therein to provide for desired properties of a composite material (e.g., consider strength, bendability, thermal conductivity, electrical properties, etc.).

As an example, a polymeric material, a polymeric matrix, etc. may include polyether ether ketone (PEEK), ethylene tetrafluoroethylene (ETFE) or PEEK and ETFE.

As an example, one or more methods described herein may include associated computer-readable storage media (CRM) blocks. Such blocks can include instructions suitable for execution by one or more processors (or cores) to instruct a computing device or system to perform one or more actions.

According to an embodiment, one or more computer-readable media may include computer-executable instructions to instruct a computing system to output information for controlling a process. For example, such instructions may provide for output to sensing process, an injection process, drilling process, an extraction process, an extrusion process, a tape forming process, a pumping process, a heating process, etc.

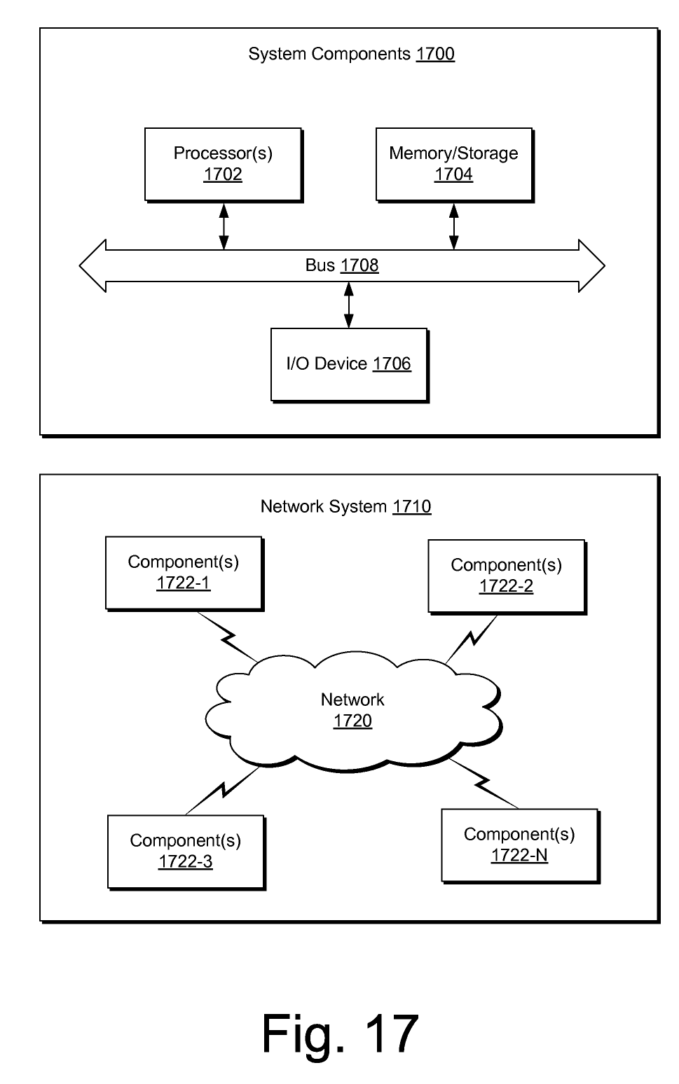

FIG. 17 shows components of a computing system 1700 and a networked system 1710. The system 1700 includes one or more processors 1702, memory and/or storage components 1704, one or more input and/or output devices 1706 and a bus 1708. According to an embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). According to an embodiment, a computer-readable medium may be a storage component such as a physical memory storage device, for example, a chip, a chip on a package, a memory card, etc.

According to an embodiment, components may be distributed, such as in the network system 1710. The network system 1710 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1702-2 may include an I/O device for display and optionally interaction with a method. The network may be or include the Internet, an intranet, a cellular network, a satellite network, etc.

### CONCLUSION

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A power cable comprising:
a conductor; and
a layer disposed radially about the conductor wherein the layer comprises graphene nanosheets in a polymeric matrix.

2. The power cable of claim 1 wherein the layer comprises an extruded layer.

3. The power cable of claim 1 wherein the layer comprises a tape layer.

4. The power cable of claim 1 wherein the power cable does not include a lead (Pb)-based barrier layer.

5. The power cable of claim 1 further comprising at least one motor lead extension.

6. The power cable of claim 5 wherein the motor lead extension comprises a conductor and a layer disposed radially about the conductor wherein the layer comprises graphene nanosheets in a polymeric matrix.

7. The power cable of claim 1 comprising three of the conductors wherein each of the conductors comprises a respective layer disposed radially thereabout that comprises graphene nanosheets in a polymeric matrix.

8. The power cable of claim 1 comprising at least three conductors for delivery of multiphase power directly or indirectly to a motor of an electric submersible pump.

9. The power cable of claim 1 wherein the polymeric matrix comprises polyether ether ketone.

10. The power cable of claim 1 wherein the polymeric matrix comprises ethylene tetrafluoroethylene.

11. The power cable of claim 1 wherein the layer comprises properties characterized by a carbon dioxide gas transmission rate that is at least one order of magnitude less than that of the polymeric material without the graphene nanosheets.

12. A method comprising:
providing graphene nanosheets in a polymeric matrix as a tape; and
wrapping the tape about a conductor.

13. The method of claim 12 wherein the conductor comprises a conductor of a power cable or a motor lead extension.

14. The method of claim 12 wherein the wrapping comprises wrapping the tape about a layer disposed about the conductor.

15. The method of claim 12 wherein the polymeric matrix comprises polyether ether ketone, ethylene tetrafluoroethylene or polyether ether ketone and ethylene tetrafluoroethylene.

16. A method comprising:
providing graphene nanosheets in a polymeric matrix; and
extruding the graphene nanosheets in the polymeric matrix about a conductor.

17. The method of claim 16 wherein the conductor comprises a conductor of a power cable or a motor lead extension.

18. The method of claim 16 wherein the extruding comprises extruding the graphene nanosheets in the polymeric matrix about a layer disposed about the conductor.

19. The method of claim 16 wherein the extruding aligns the graphene nanosheets.

20. The method of claim 16 wherein the polymeric matrix comprises polyether ether ketone, ethylene tetrafluoroethylene or polyether ether ketone and ethylene tetrafluoroethylene.
